(19) United States
(12) Patent Application Publication
(10) Pub. No.: US 2006/0283258 A1
(43) Pub. Date: Dec. 21, 2006

(54) Fluid mechanics of inertia, or acceleration mechanics, or simplified calculus

(76) Inventor: Richard Lee Chastain, Louisville, KY (US)

Correspondence Address: Richard L. Chastain, 136 Stoke on Trent, Louisville, KY, 40299, US

(21) Appl. No.: 11/156,204

(22) Filed: Jun. 17, 2005

(51) Int. Cl. G01B 5/30; G01B 7/16

(52) U.S. Cl. 73/760

(57) ABSTRACT

Fluid Mechanics of Inertia incorporates all the variables of flight mechanics, interplanetary ballistics, perpetual motion, human powered transportation, and all aspects of fluid mechanics involving matter, energy, and motion, and includes elastic fluids into the definition of “fluids”. The “Mechanics” in Fluid Mechanics, may mistakenly be construed to be dynamics. Fluid Mechanics of Inertia is simplified calculus and converts calculus to trigonometry, logarithms, geometry, algebra, and basic functions. Fluid Mechanics of Inertia is a three dimensional math occurring in a time frame of no elapsed time although the locomotive animation of life is at full locomotive performance, the “snap-shot” elapsed time is zero, except where elapsed time is derived to elapse a time interval of a prescribed time allowance duration which is described, and there is no motion, thus “dynamics” does not occur in these problems since time is zero.

### BACKGROUND OF THE INVENTION—FIELD OF INVENTION

Fluid mechanics of Inertia is the science of motion, energy, and matter, not unlike dynamics.

### BACKGROUND OF INVENTION—DISCUSSION OF PRIOR ART

Matter, energy, and motion equations have been engineered by many renowned scientists. Formulas are in the public domain in some statics problems, trigonometry, some geometry, algebra, and basic functions. The logarithms function herein proves the calculator logarithm function to be obsolete if not unusable. Fluid Mechanics of Inertia includes the elastic equilibrium of fluids (as solid) as an element essential required to introduce fluid displacement and possessing the capacity to introduce fluid reactions to the same or other states of matter and therefore elastic fluids are included in Fluid Mechanics of Inertia. Elastic fluids displace fluids, elastic gases displace fluid gases, and solids are left to the imagination of the inventor. Sprockets designs and aircraft's rotary wing effectiveness are also reengineered here for particular focus on human powered flight. Important variables have always been omitted in prior art—particularly, to include air resistance in equations in introductory college course equations. The rationale contained in the contemporary calculator answer to a logarithm equation is useless and may only be solved on the calculator which gives an answers which serves no common purpose for anybody, until now. The Calculus has never proven satisfactory for solving dynamic problems with a simple mathematical means. Solving no-elapsed-time velocity problems is solved here in these problems. Acceleration of gravity is not 32 feet per second per second, by the deductive reason of the math in these problems. All aircraft are designed to carry a wide range of individuals' sizes and today's aircraft may be more easily stolen from individuals whose aircraft is more user friendly than an aircraft specifically tailored to fit only one individual. Although more expensive to tailor an aircraft to one individual's specifications, human powered flight makes tailoring aircraft necessary and this Fluid Mechanics of Inertia makes it possible to and therefore facilitates human powered flight by aligning individual characteristics to the mathematical design for flight per person, for which Fluid Mechanics of Inertia is devised and is intended to be used to apply for patents on human powered transportation once the software tools from the algorisms in this process invention makes it possible to design the transportation means completely to individual's specifications and mechanical engineering. Ornithology of flight is conclusively resolved in these algorism formulas if mitosis balances and a bird results.

Fluid Mechanics of Inertia will make wind tunnel testing a tradition, if not obsolete. The software will make ordinary individuals into rocket scientists, giving them the household ability to design aircraft, vessels, vehicles, and spacecraft. Fluid Mechanics of Inertia does not neglect the necessity to include fluids resistances in its designing of aircraft and spacecraft, vehicles and vessels.

Computer Aided Designing software programs separate different types of transportation designing Compact Disc packages into individual software programs for retail sale separately for the most profit, and are not commonly available to the public as one unit quantity device or presented to them as a complete tool, in one user friendly software CD package, doing everything. With the creation of the user friendly software toolbar tools from this process information there may be many inventions.

This process invention eliminates numbers as a device to encumber men for their failure to invent on account of their lack of understanding for their use for numbers and eliminates numbers as a device of burden against them as a tool of abuse to have to impose on them to invent, and invents the necessity of the new ideal concepts which are not yet conceived by man in our understanding of revelations of evolution of invention as yet undetermined and unperceived by the understanding of mankind of new things to come into existence that do not exist today. Accuracy of equations is sub-molecular. Assembly of parts may be accurate to 1/100 inch. Fluid equations which occur continually, can have a zillion trillion calculations in one equation, due to their atomic structure, which variables continually apply undeterminable different values from moment to moment. Machines capable of producing the fluid equations solutions of continually unique values is a new ideal concept of revelation of invention.

The following pages contain simple acceleration/momentum algorithm laws, geometry, trigonometry, and algebra equations which define geometric parameters of tailoring the performance of transportation designs to the operator's specifications, a perpetual motion algorism, and human powered powerplant with a design pretense of the capability of possibly going supersonic. Fluid Mechanics of Inertia involves fly-by-the-seat-of-your-pants interplanetary ballistics equations, the operator's tools for which will be: a stopwatch, pen, paper, sextant, ignition, throttle, a calculator, and an education, in order to be able to operate a space ship successfully.

### Parts Numbers—Names

16—unsymmetrical geometrical volume shape
20—pedal
22—crank arm
24—chain ring
26—chain
28—flywheel
30—flywheel frame mount
32—flywheel driven sprocket
44—planet gears diagram
48—horizontal stabilizer
50—tail rotor blade
52—tail blade pitch control mechanism
54—output flow impellor gallery
56—fluid reservoir
58—blade
60—vertical stabilizer
62—aircraft main airframe
64—fluid collector
66—hydraulic fluid passageway
67—brazing sleeve
68—power transmission
69—power transmission epicyclic gears
70—transverse power transmission bracing airframe members
72—rear landing gear
74—power train driven sprocket
76—power train main drive chain
78—front landing gear
80—steering control linkage
82—handlebars
84—saddle
86—tail rotor pitch trim control linkage
88—operator's mainframe
90—locomotion control valve
91—locomotion control valve lever
92—locomotion control valve lever control linkage connection
94—rear wheel drive axle
96—rear wheel
98—brake cable and encasement
100—reverse flow valve
102—blades guard
104—blades engaging/disengaging valve
106—blades engaging/disengaging valve control linkage connecting rod
108—control linkage bell crank
110—brake lever
112—forward/reverse valve control lever (left), blades engage/disengage valve control lever (center), stop/go/slow-fast control lever (right)
114—steering control arm
116—A-frame
118—main body frame
120—steering arm
122—tire and wheel

### DETAILED DESCRIPTION, FIG. X-x EXPLAINED

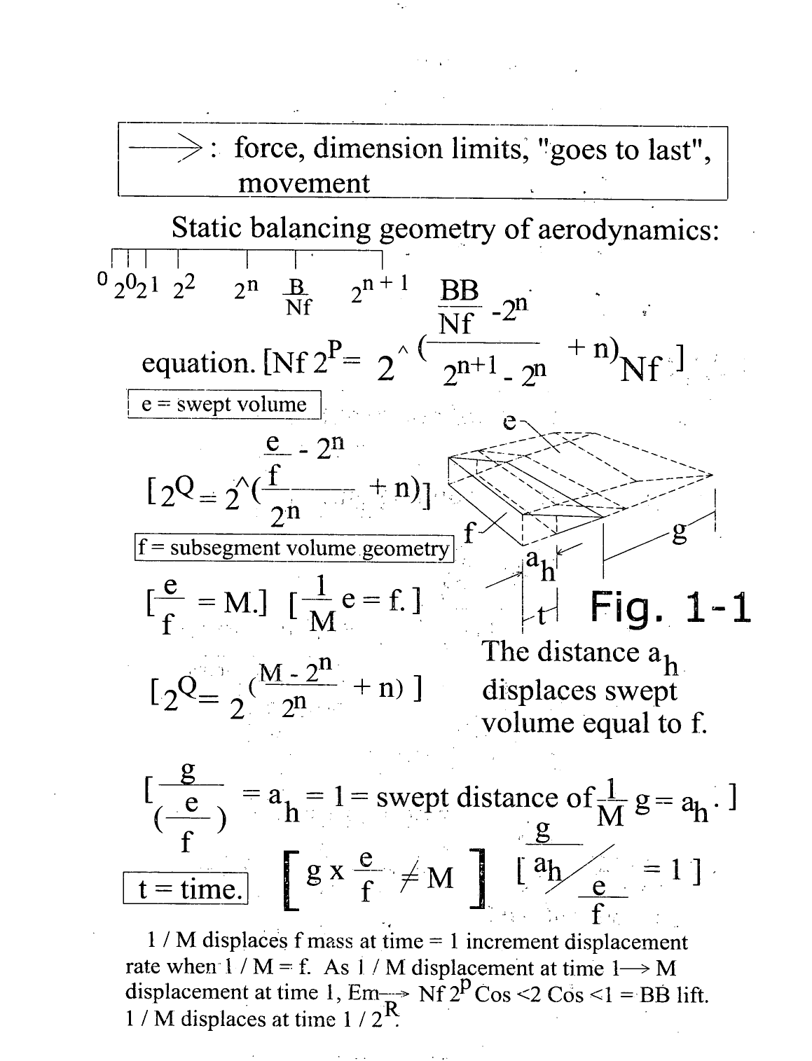

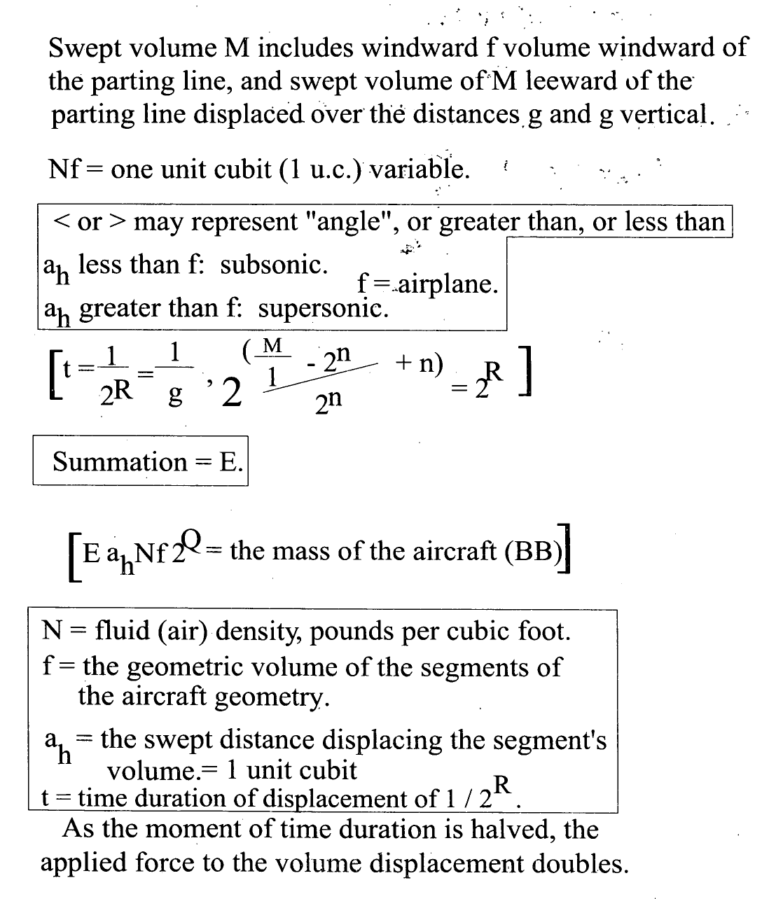

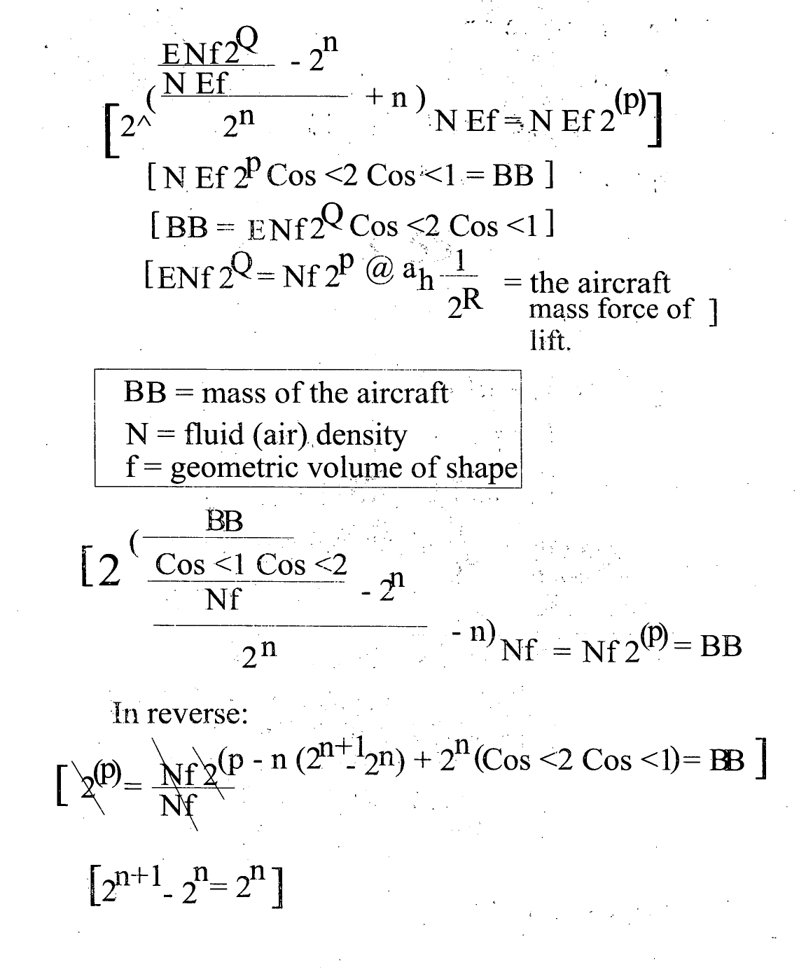

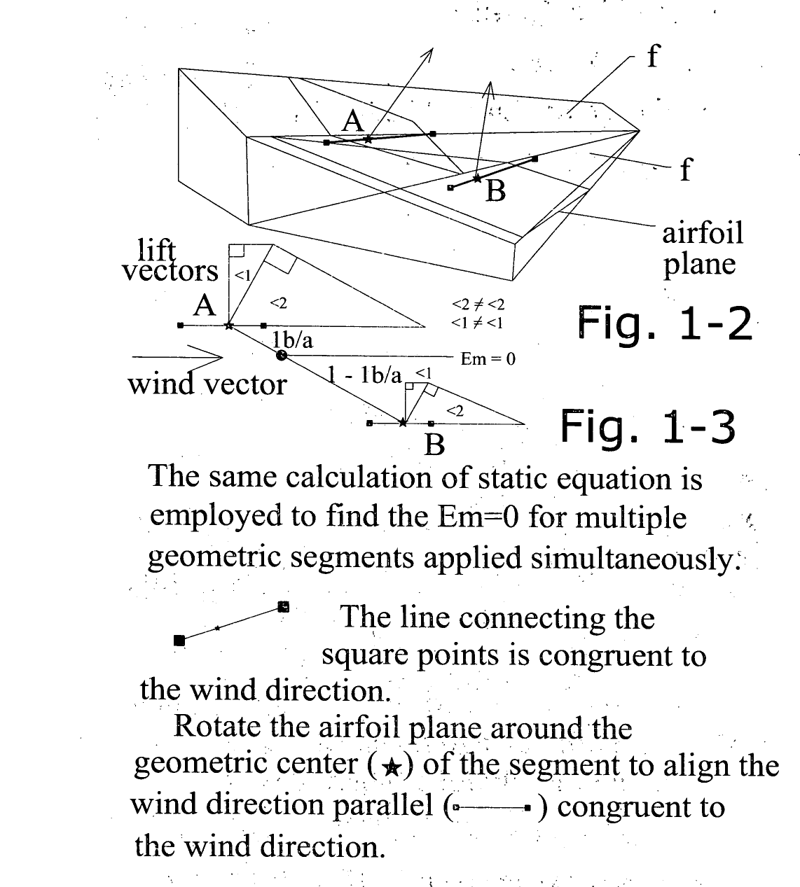

FIG. 1-1: geometric volume displacing distance and displacing the volume of the displacing volume once.

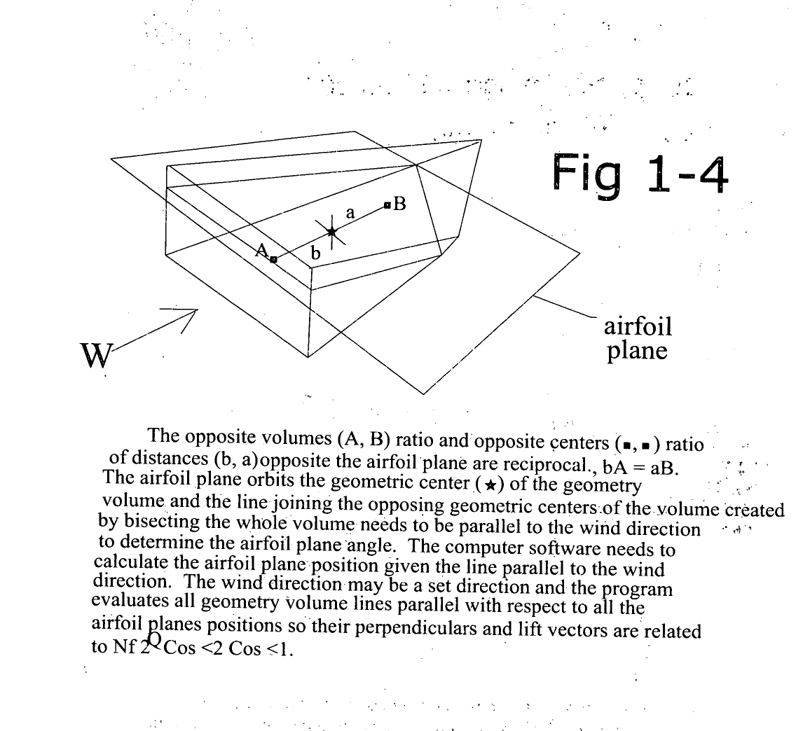

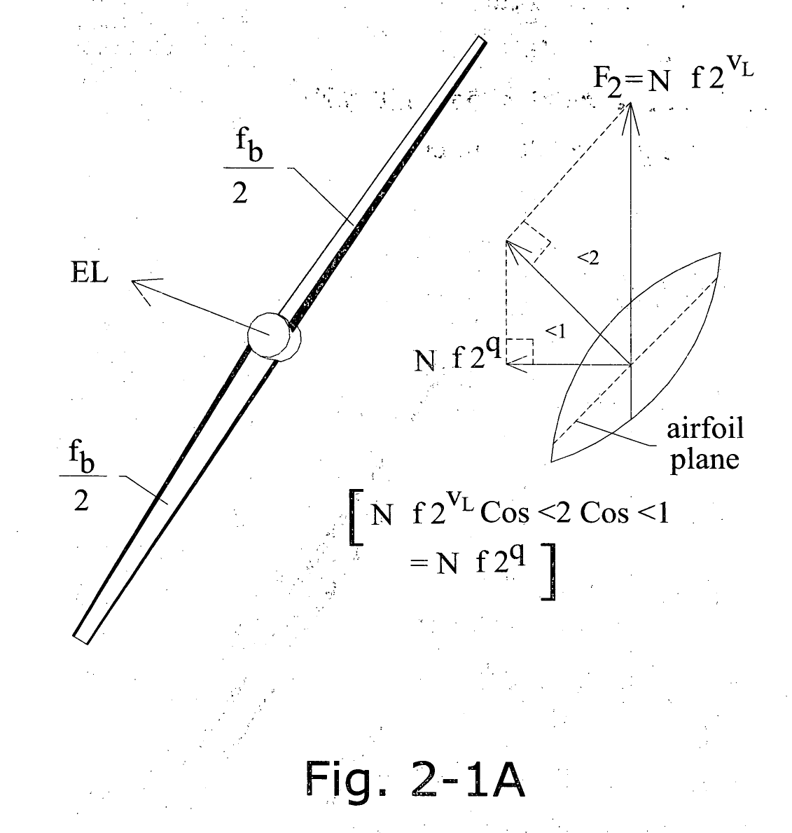

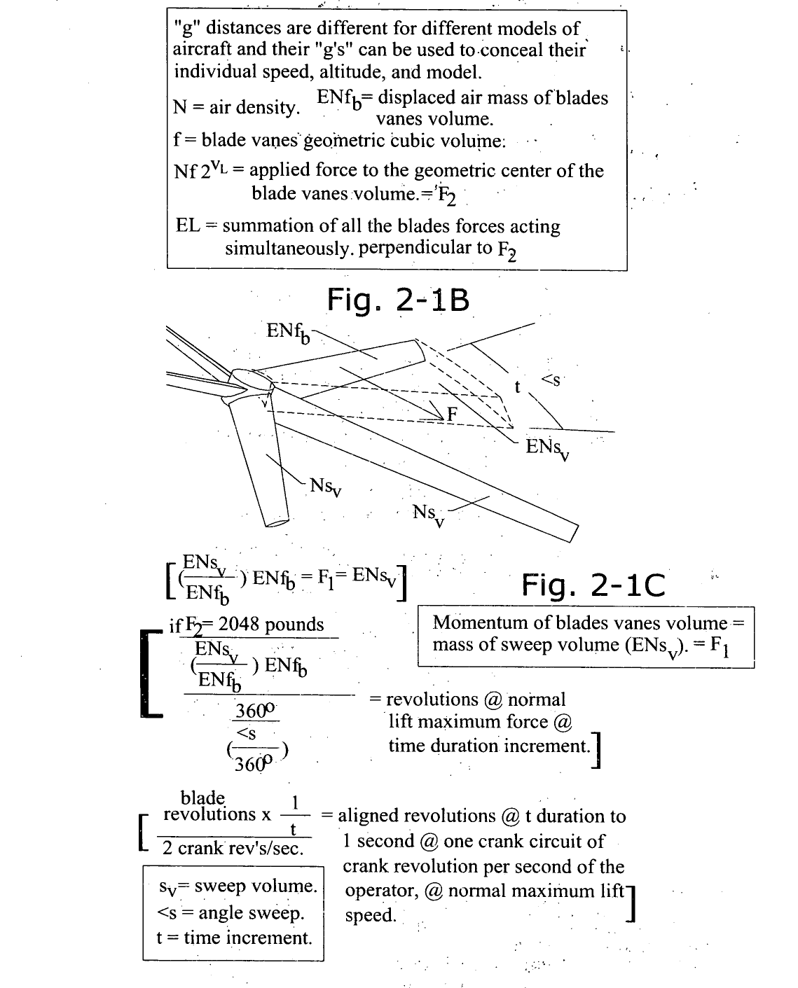

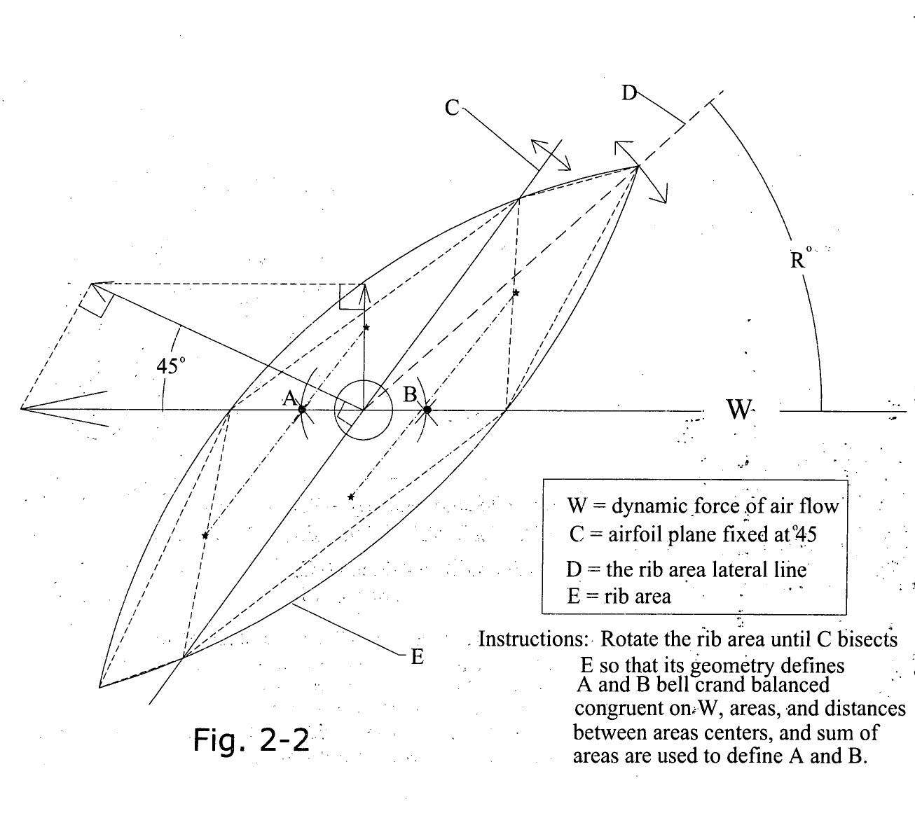

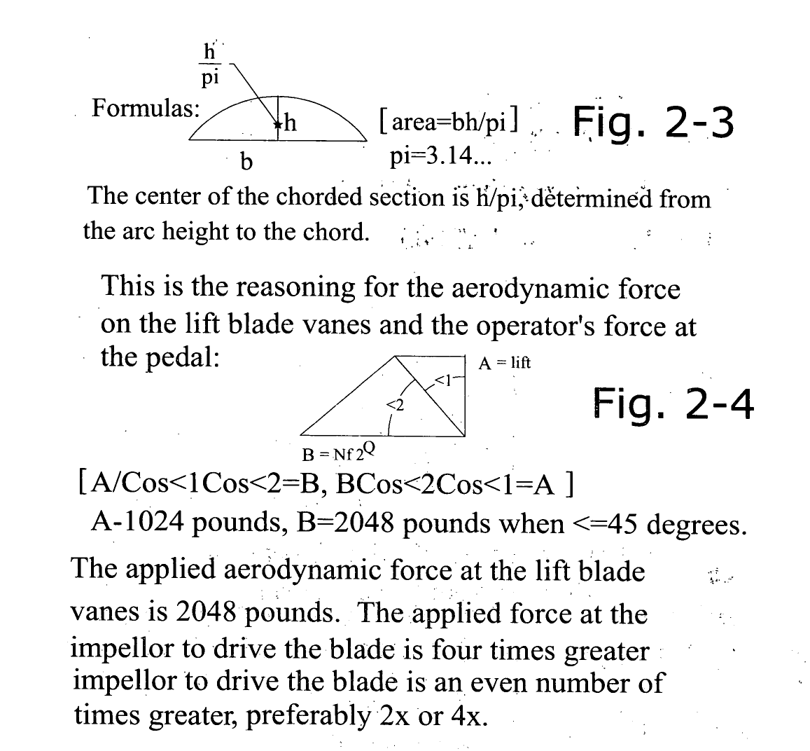

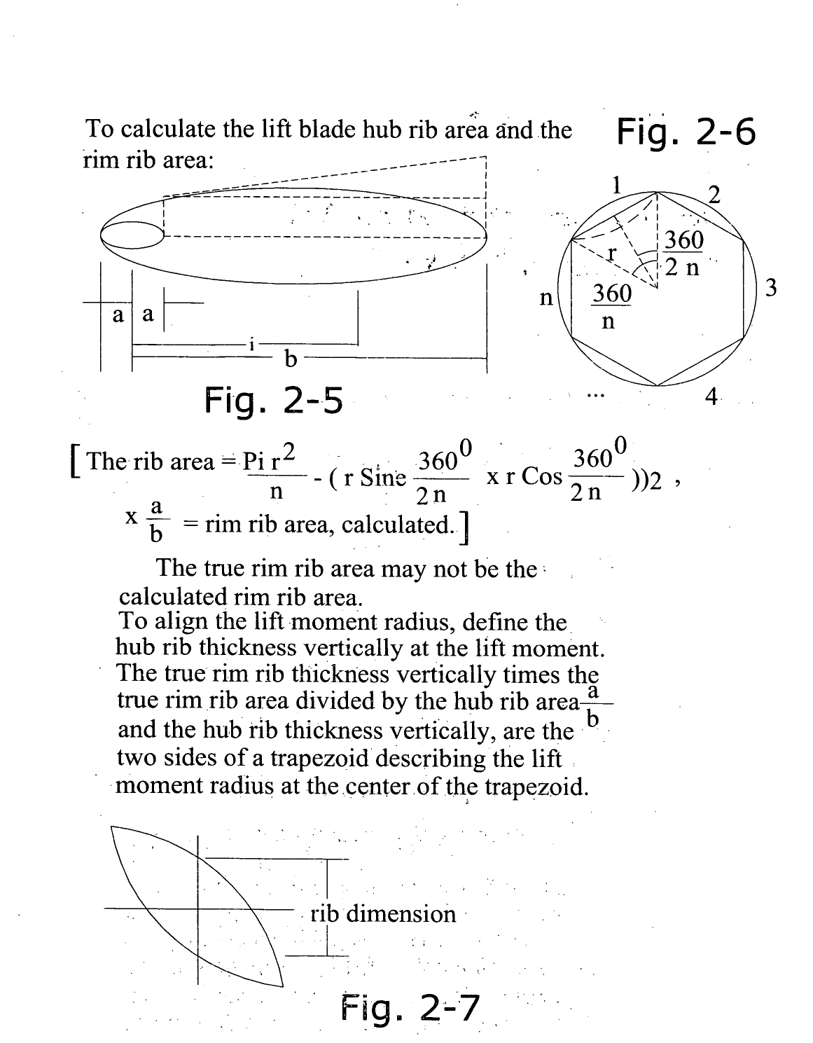

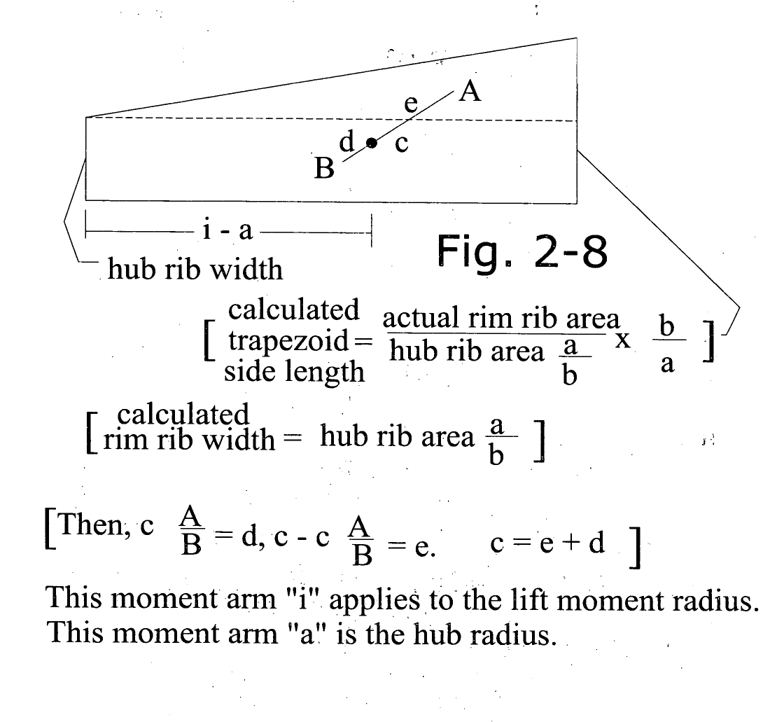

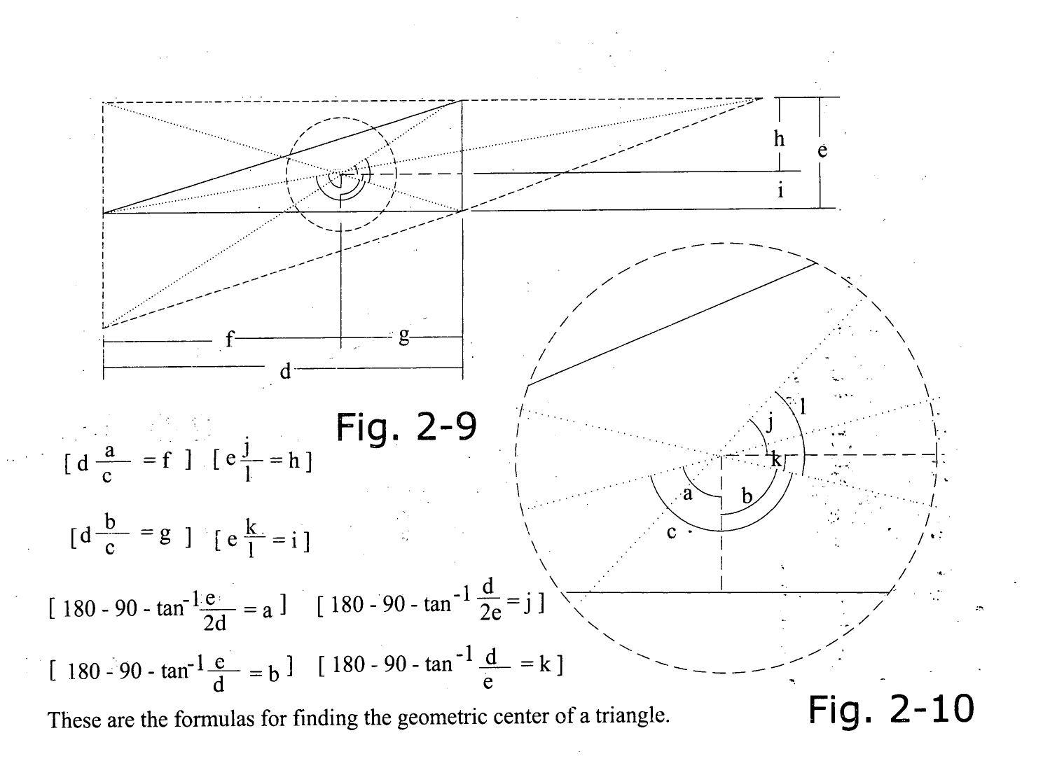

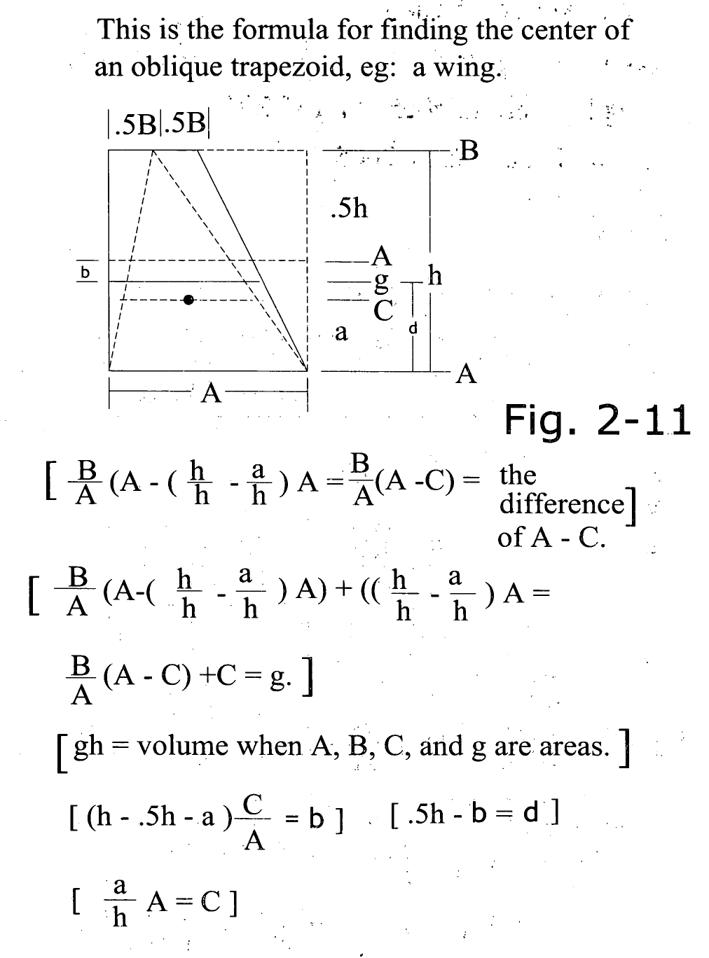

FIG. 1-2: multiple geometric volumes having their volumes bisected by airfoil planes of different angles. The volumes' centers opposite the airfoil planes' centers are congruent to wind direction resulting in the angle of the airfoil planes by default individually.

FIG. 1-3: the bell crank balancing of individual segments volumes experiencing wind effect influence and their corresponding perpendicularly resulting vectors and their respective magnitudes individually. Their angles are different.

FIG. 1-4: another diagram of the relationship of the airfoil plane with the wind acting on a body volume.

FIG. 2-1A: blade vanes force diagram and equations.

FIG. 2-1B: variables of FIG. 2-1A, and relative “g” value.

FIG. 2-1C: calibration of duration and sweep angle where blade vanes momentum equals sweep angle volume mass simultaneously, and related equations.

FIG. 2-2: blade vane (E) nominal pitch (R@D) to apply minimum force with maximum lift, and the geometry and trigonometry to balance the opposite segments volumes centers (A-B) congruent to the wind vector (W) and produce the airfoil plane (C) angle (45).

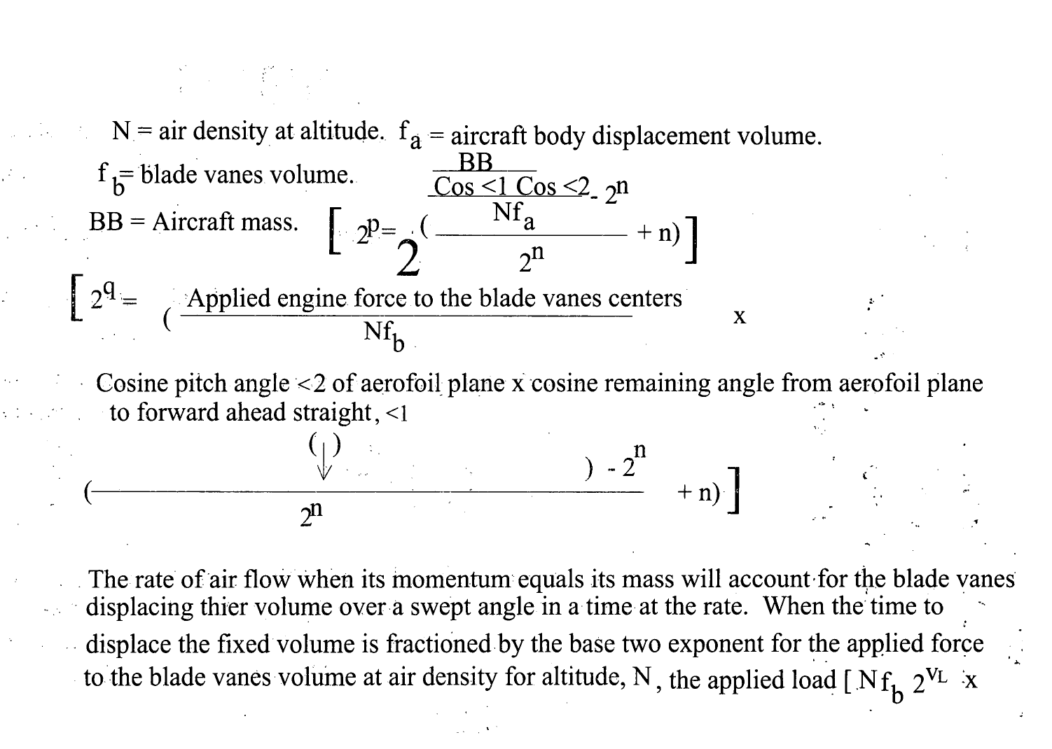

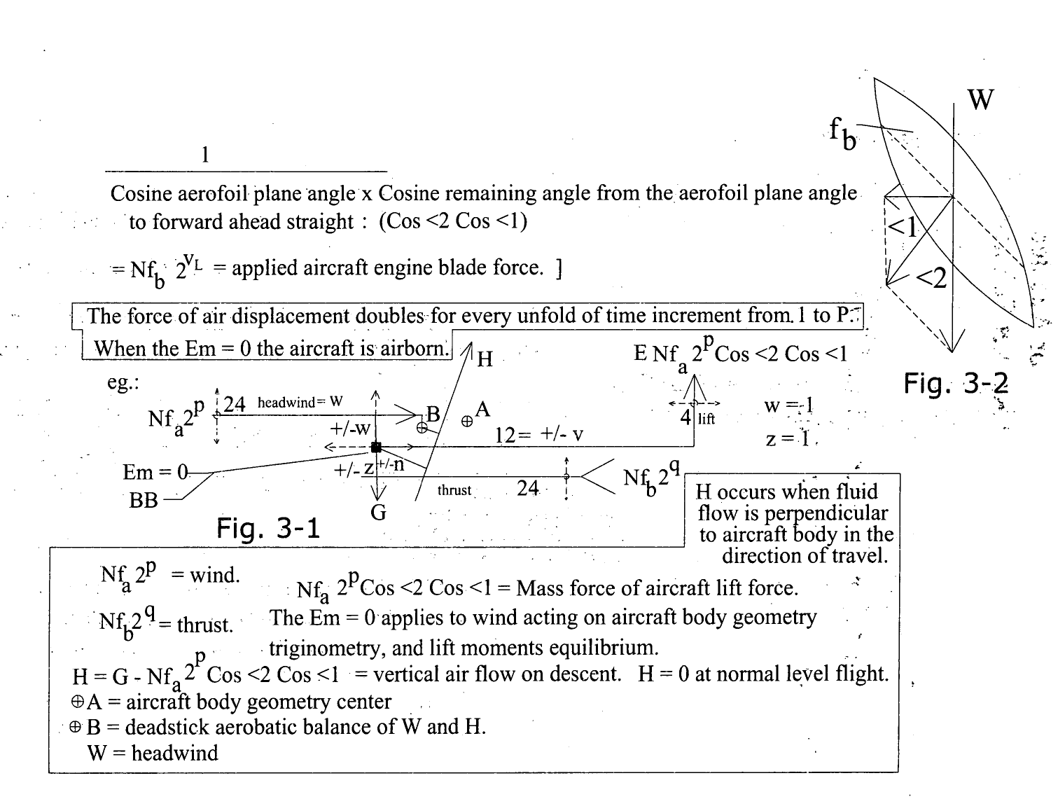

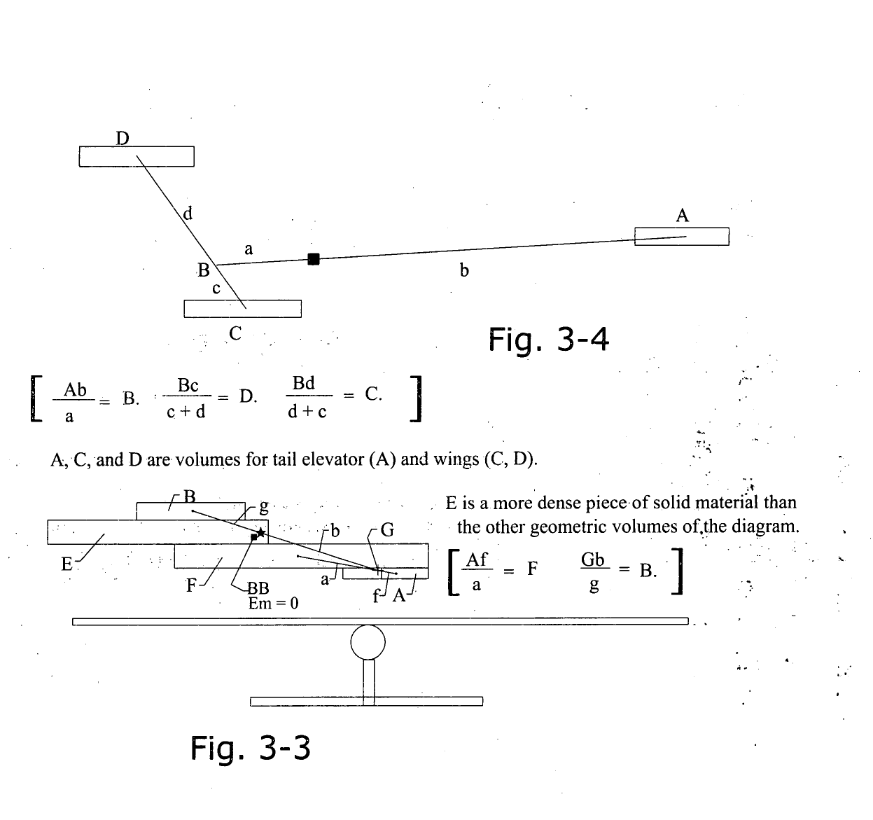

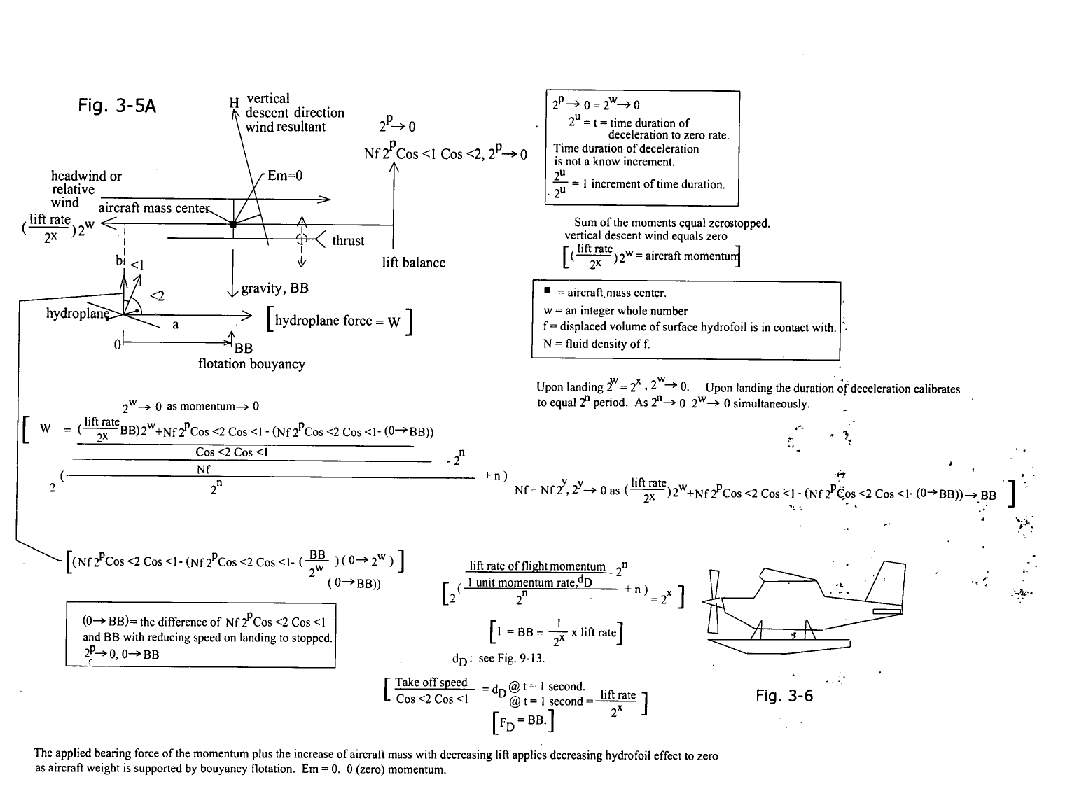

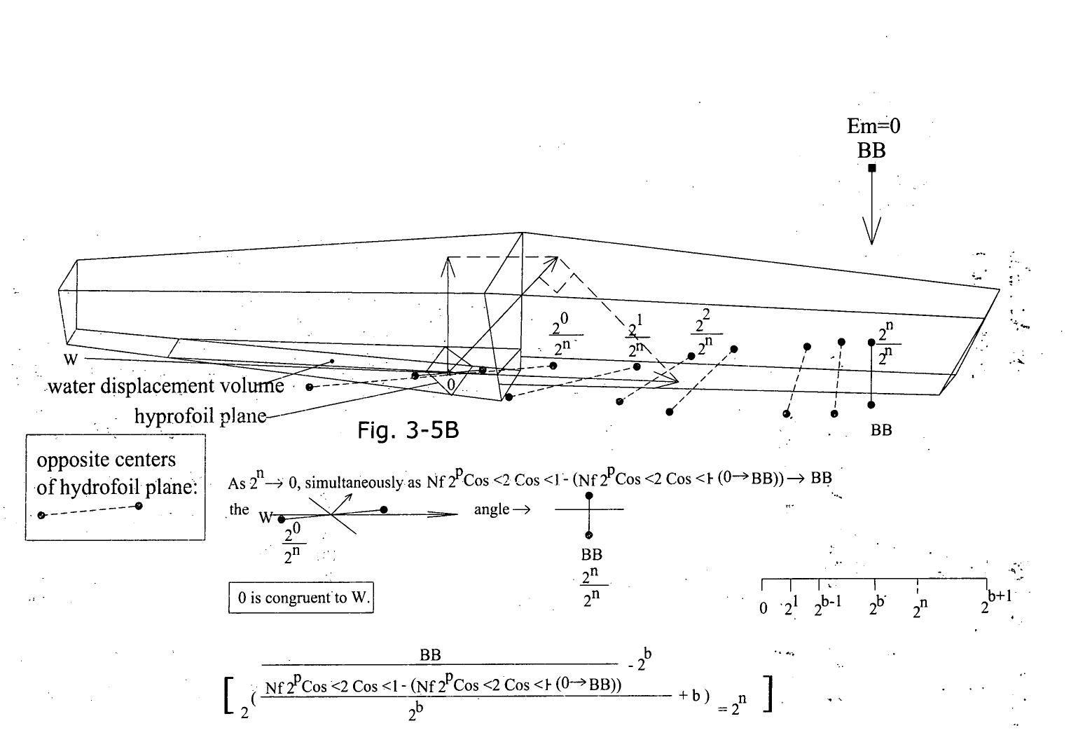

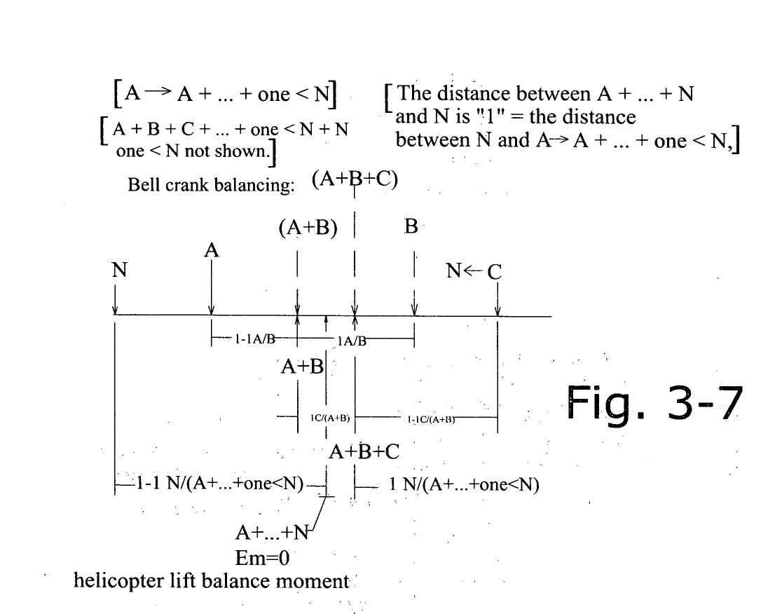

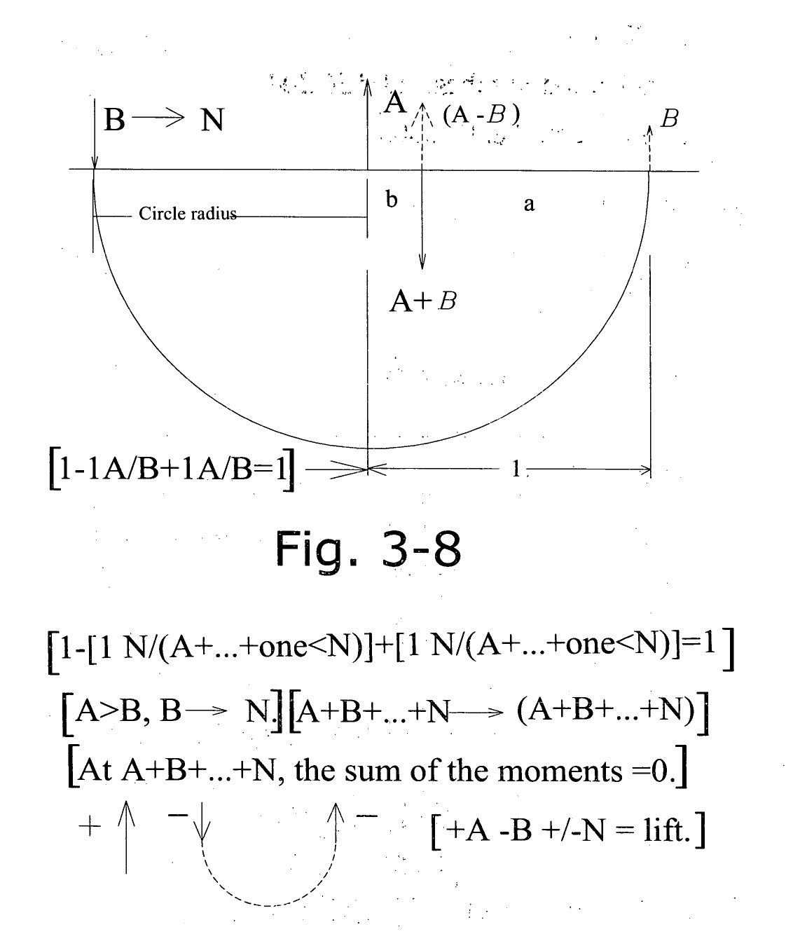

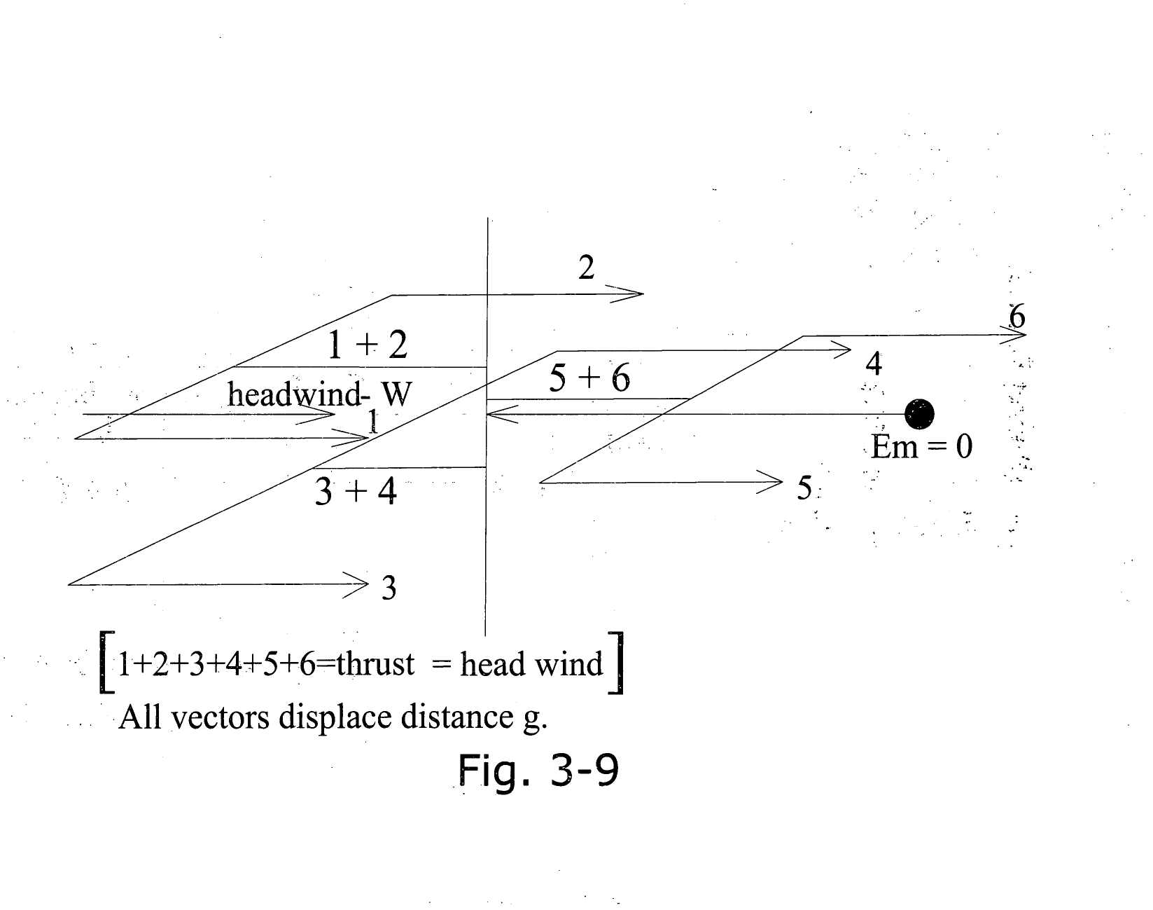

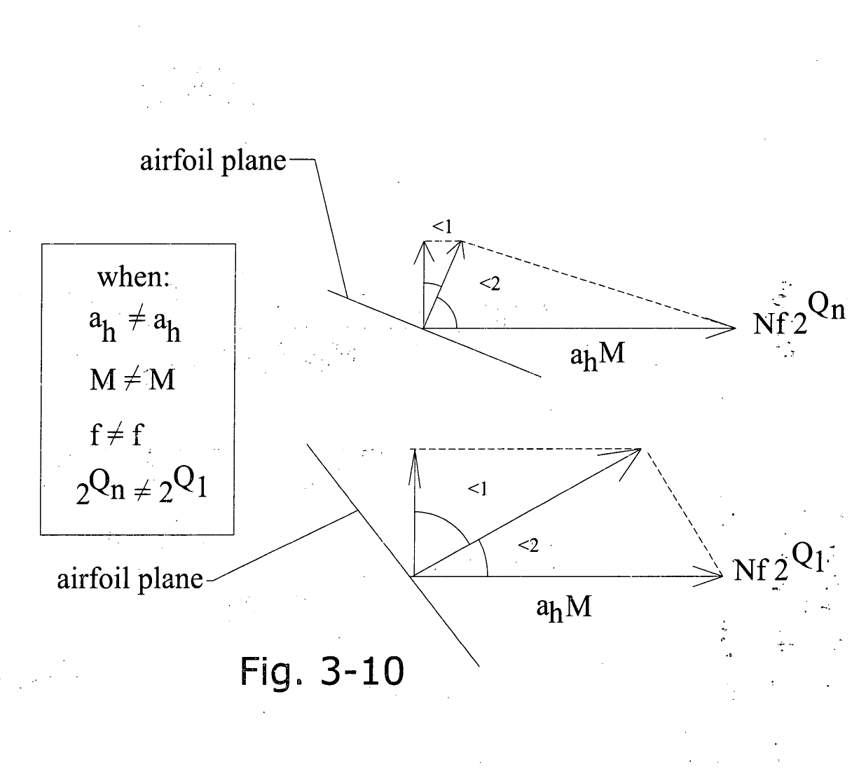

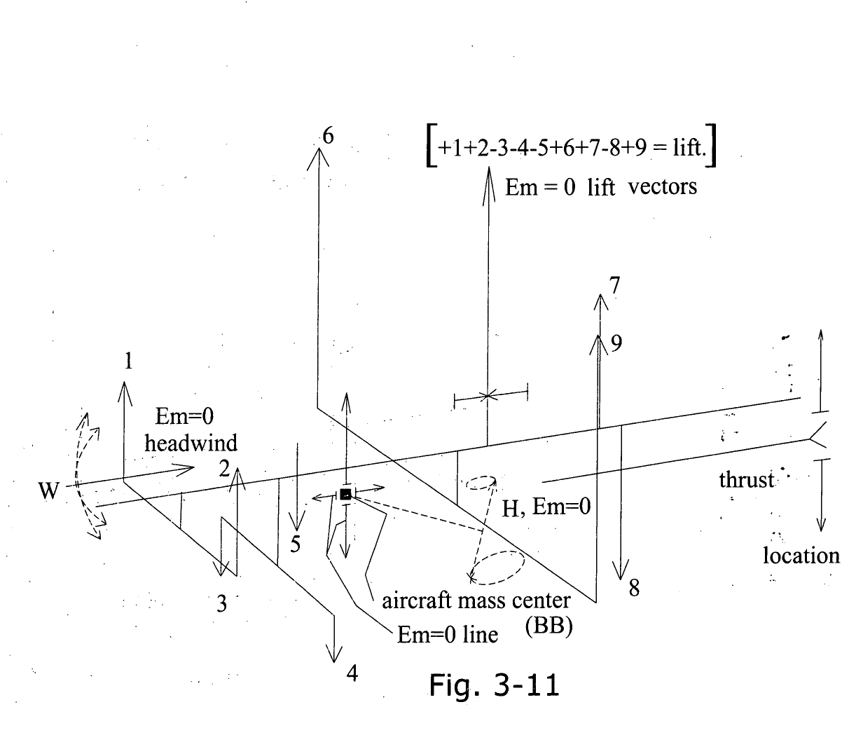

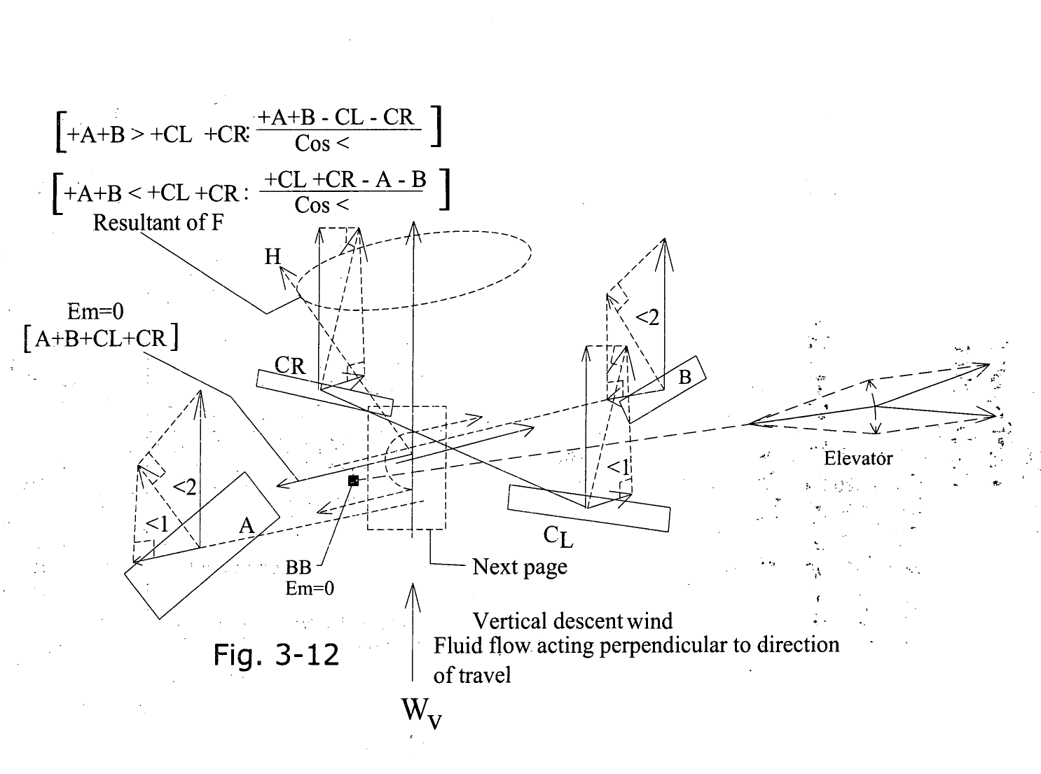

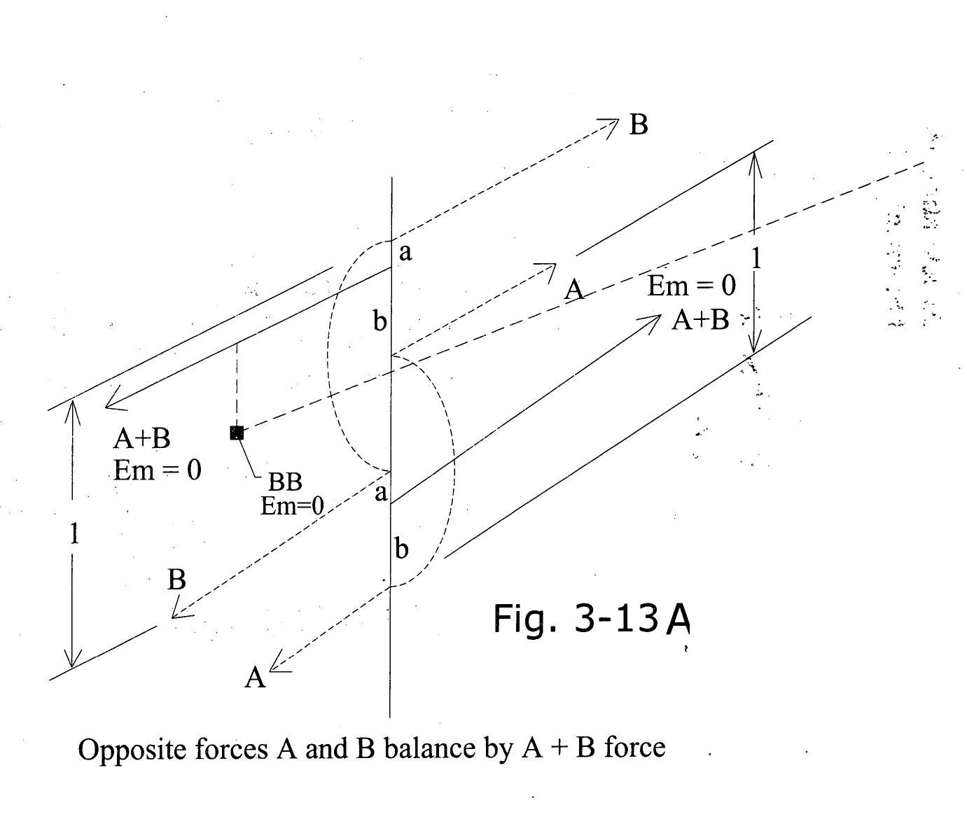

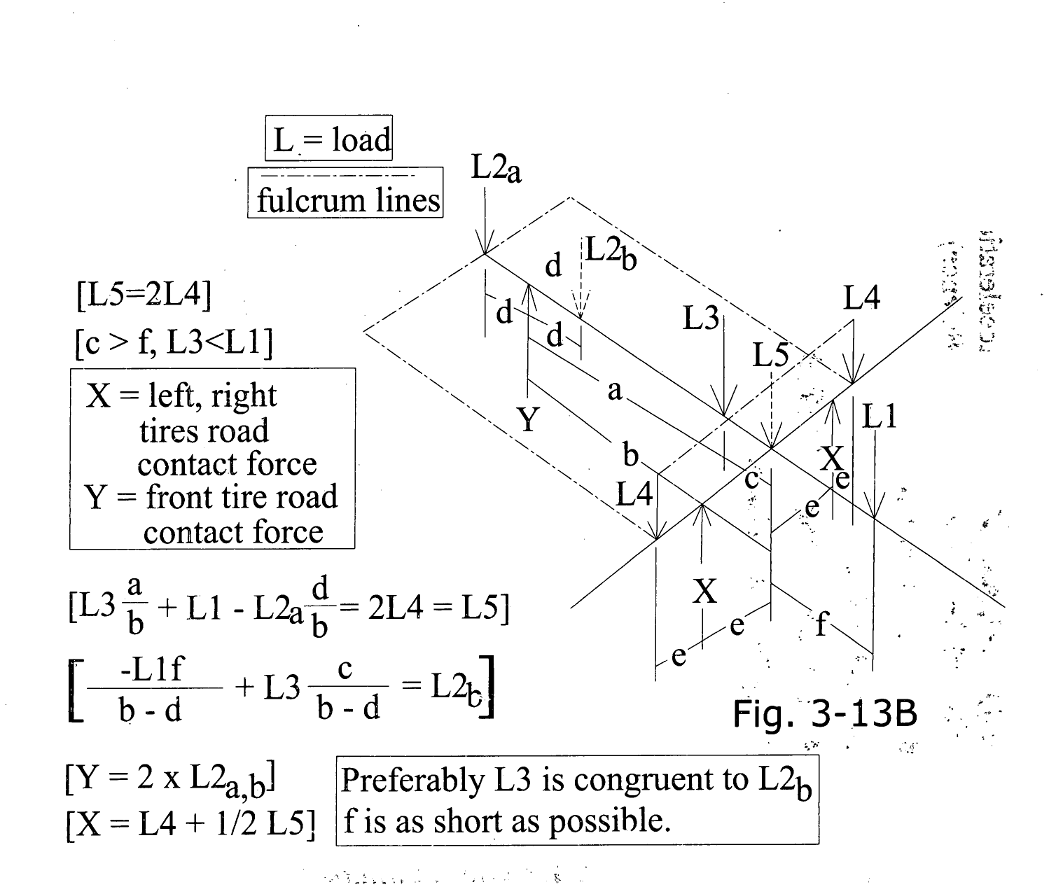

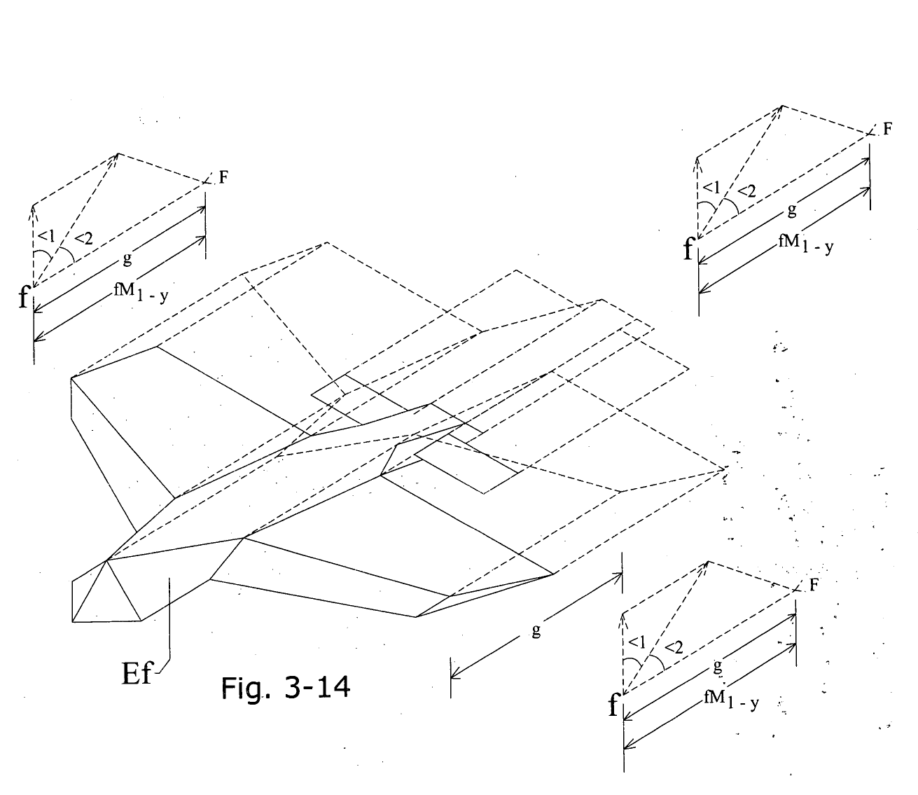

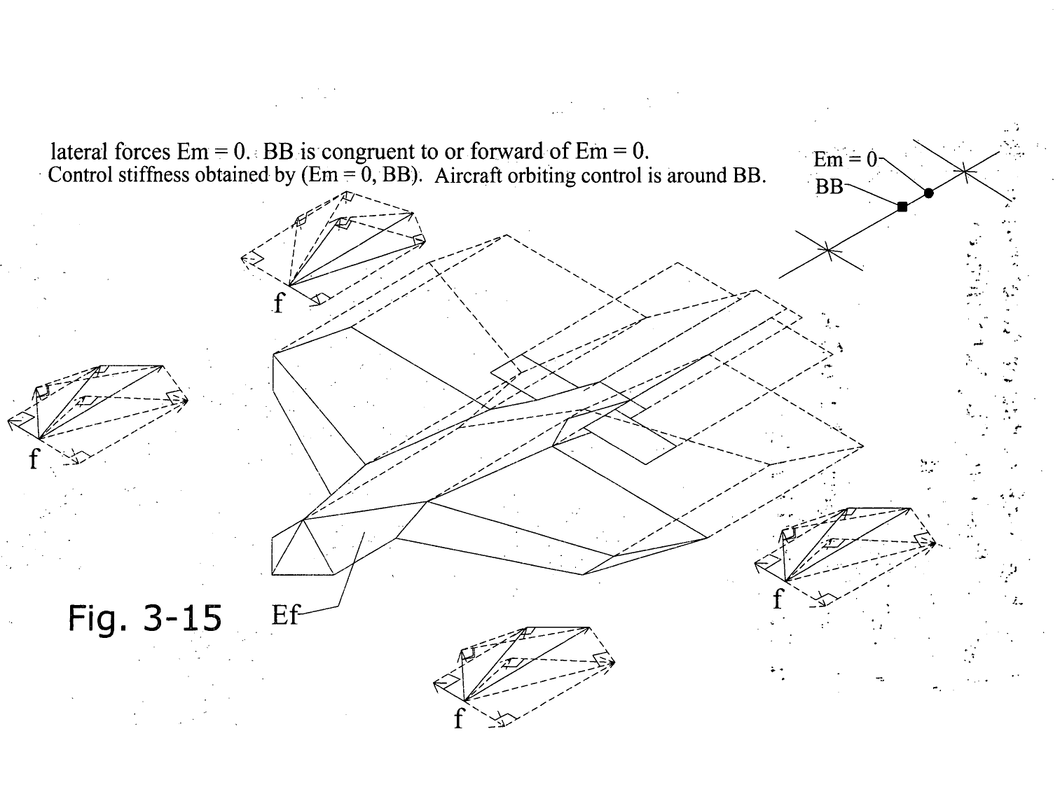

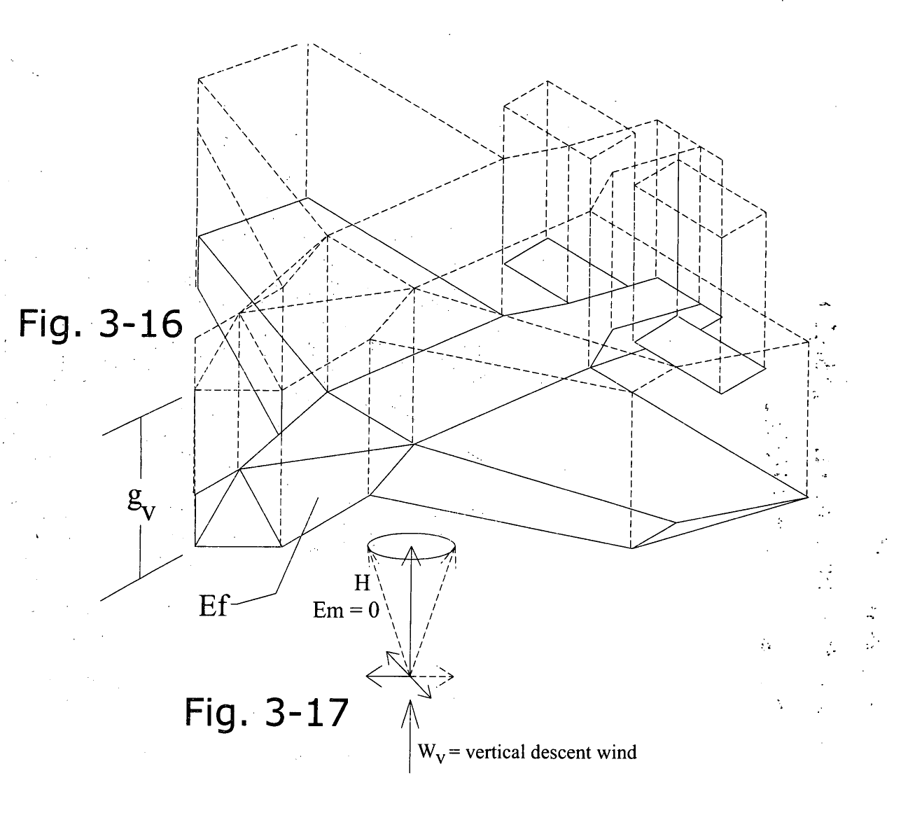

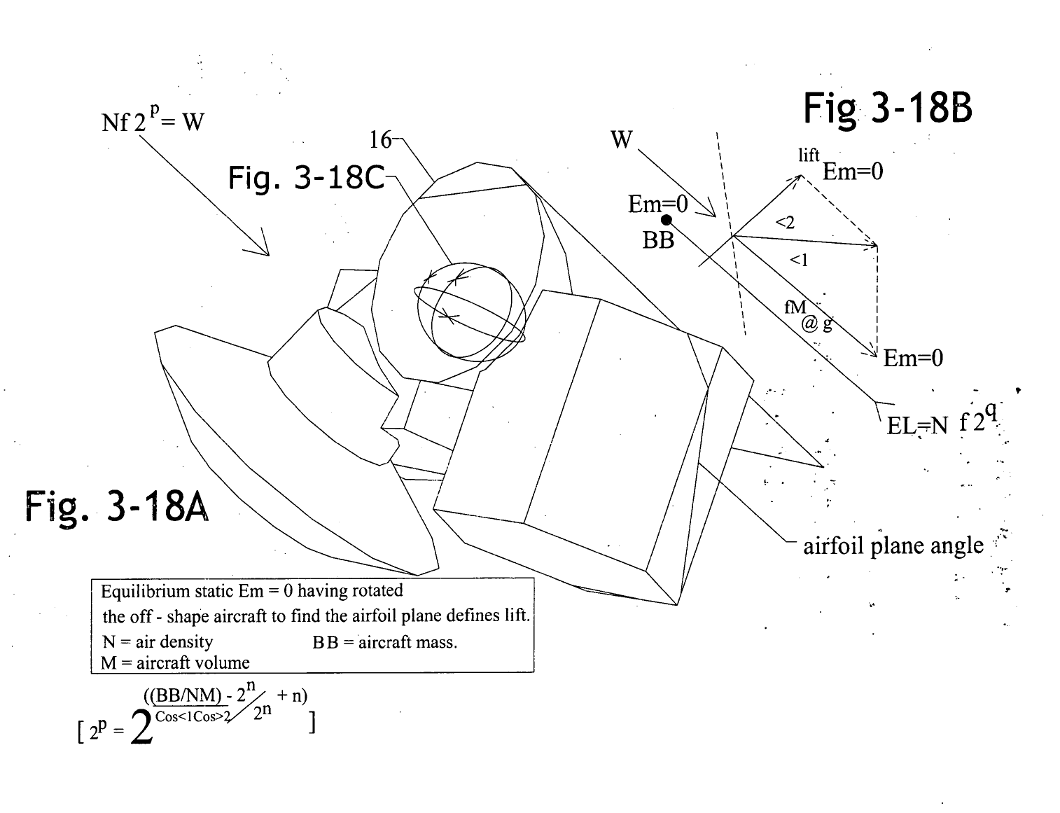

FIG. 2-3: the diagram of a chord (b) area formula and chord area center formula and chord area center.

FIG. 2-4: the establishment of which angle is angle 1 (<1) and which angle is angle 2 (<2).

FIG. 2-5: the radius of the blade vane hub rib (a) with respect to the rim rib radius (b) and the lift moment radius (i).

FIG. 2-6: diagram of variables taken to calculate the rib area:
(r—radius n—divisions 360—degrees/circle)

FIG. 2-7: the diagram of the rib with respect to the gauge of the measurement taken to work FIG. 2-8.

FIG. 2-8: the force diagram of the blade vanes rib areas in static performance at applied force (i−a).

FIG. 2-9: the diagram showing the dimensions for the center of a triangle.

FIG. 2-10: the enlargement view of the relationship of the algebraic variables to calculate the lesser dimensions of the two shorter sides of the triangle.

FIG. 2-11: the diagram and calculations of the center rib dimensions of a trapezoidal wing shape.

FIG. 3-1: the static balancing diagram of an airplane.

FIG. 3-2: blade vane static force diagram, see FIG. 2-1A.

FIG. 3-3: the static balancing diagram of a glider having no aerodynamic lift at any speed at level flight attitude.

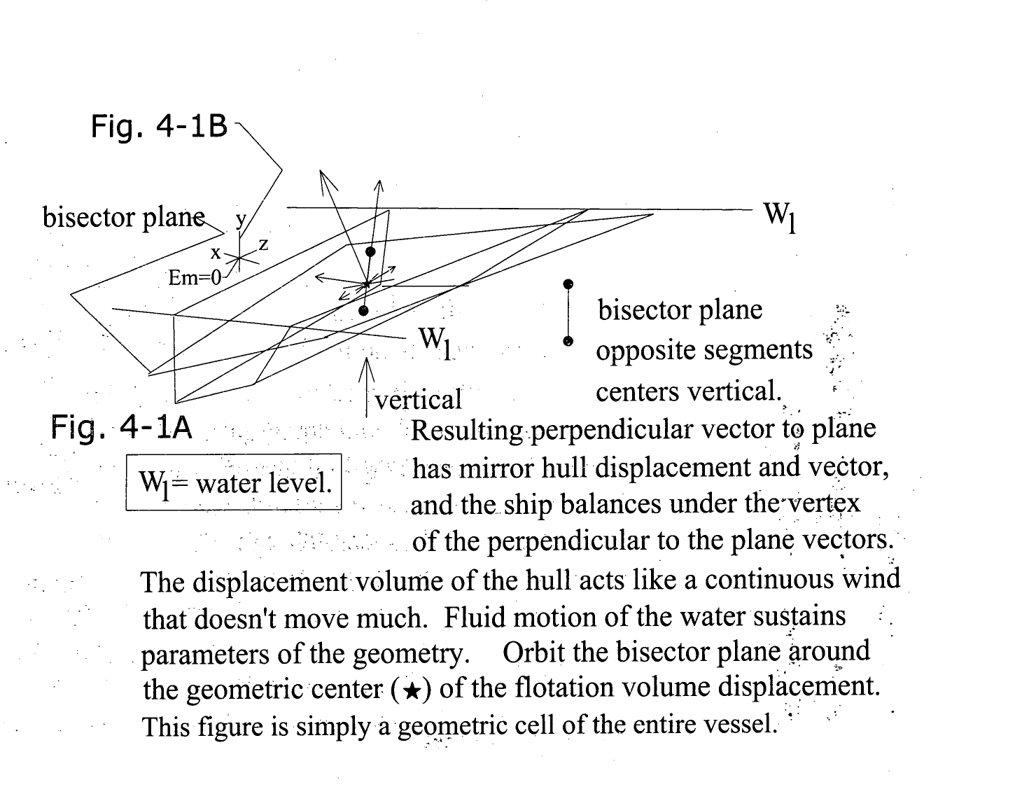

FIG. 3-4: the static balancing of the wings and elevator of a biplane glider. No aerodynamic lift is anticipated.

FIG. 3-5: static balancing diagram of an aircraft hydrofoil.

FIG. 3-5[[A]]: a hydrofoil, the leading volume displacement is the applied geometry to calculate the hydrofoil plane angle.

FIG. 3-5B: hydrofoil equilibrium, from landing to stopped.

FIG. 3-6: sketch of a hydrofoil aircraft and logical formulas and their associated variables descriptions. Compare FIG. 3-5A static balancing diagram.

FIG. 3-7: lateral static balance diagram of an assortment of lift forces acting on an aircraft's displacement experiencing aerodynamic force of fluid motion due to its shape.

FIG. 3-8: static diagram of forces with rotation moments, being balanced for lift.

FIG. 3-9: static balance diagram of three dimensional symmetrically shaped geometry having aerodynamic force acting simultaneously on individual volumes.

FIG. 3-10: variety of lift magnitudes resulting from individual volumes having individual airfoil plane angles being acted on by uniform aerodynamic force.

FIG. 3-11: resulting variety of magnitudes of lift vectors and allocating the balance moment of the lift force resulting from airfoil planes of assorted angles being created by various volumes having a variety of values for variables.

FIG. 3-12: glider descent wind resultant of vertical air flow acting on the aircraft body displacement, having perpendicularly occurring forces acting simultaneously resulting in rotation being counterrotated by the elevator force.

FIG. 3-13: counterrotating forces being balanced with the elevator.

FIG. 3-13[[A]]: landing gear static balancing diagram and formulas.

FIG. 3-13B: static balancing for tricycle landing gear.

FIG. 3-14: swept volume displacement of the aircraft body volume trailing from the parting line to include the leading aircraft body volume windward of the parting line, to equal “Ee” of FIG. 1-1.

FIG. 3-15: transverse forces balance moment center for which the aircraft's mass center may not be leeward. Swept displacement is g distance.

FIG. 3-16: vertical swept volume displacement of the aircraft body volume simultaneously in equal time to g displacement on trajectory, as descent momentum determines g-vertical distance in equal time.

FIG. 3-17: diagram of vertical wind resultant, lateral forces may be zero.

FIG. 3-18[[A]]: unsymmetrical aircraft body volume positioning diagrammatic description of three dimensional rotational alignment rationale to balance the stable forces in equilibrium to create lift and straight and level flight.

FIG. 3-18B: a simple vectors description to final acclimation of FIGS. 2-1A and 3-1, and 3-10 through 3-17 in a simple relevancy complementing the unsymmetrical aircraft body volume positioning diagram once its rotational alignment of its unique aerobatic equilibrium to W-air flow is discovered by forcibly rotating the aircraft body volume in any of three dimensions in a systematic manner to locate the airfoil plane at an attitude to W to allow straight and level flight. The location of BB is dependent on the Em=0. The airfoil plane is perpendicular to the final Em=0 lift vector. The final lift vector is vertical. The unsymmetrical geometric shape may have more than one level flight attitude.

FIG. 3-18C: Three axes individually revolved 360 degrees and rotated 360 degrees with respect to the other two axes describing at least three equidistant points on a sphere aligning equilibrium to the unsymmetrical geometrical volume shape aerobatic lift vectors to Em=0.

FIG. 4-1[[A]]: one half of hull displacement diagram describing how the foil angle is surmised and that the fulcrum vector angle is perpendicular to the foil.

FIG. 4-1B: vessel's geometric center of buoyancy equilibrium.

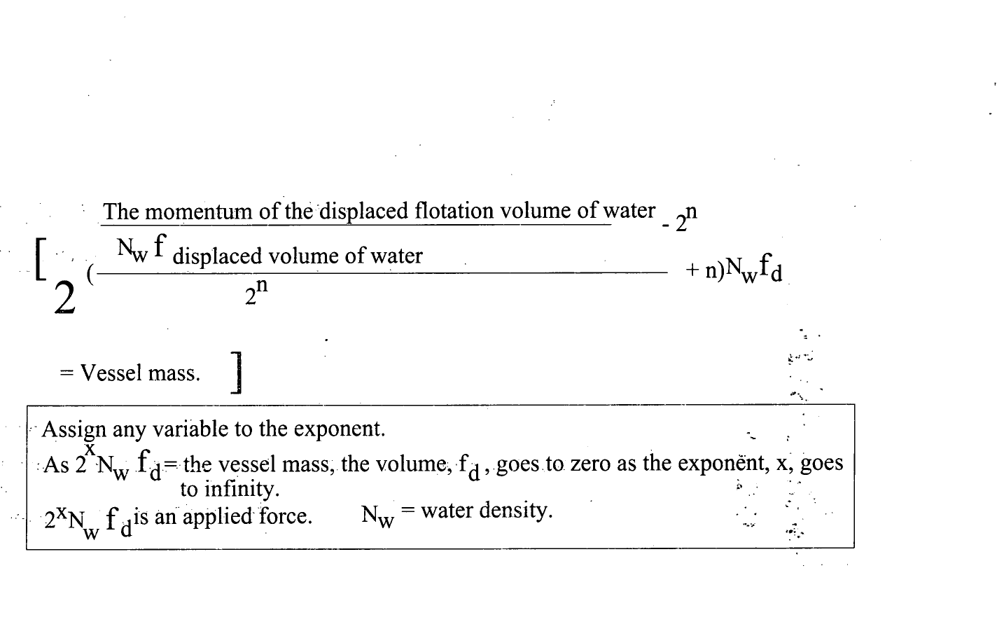

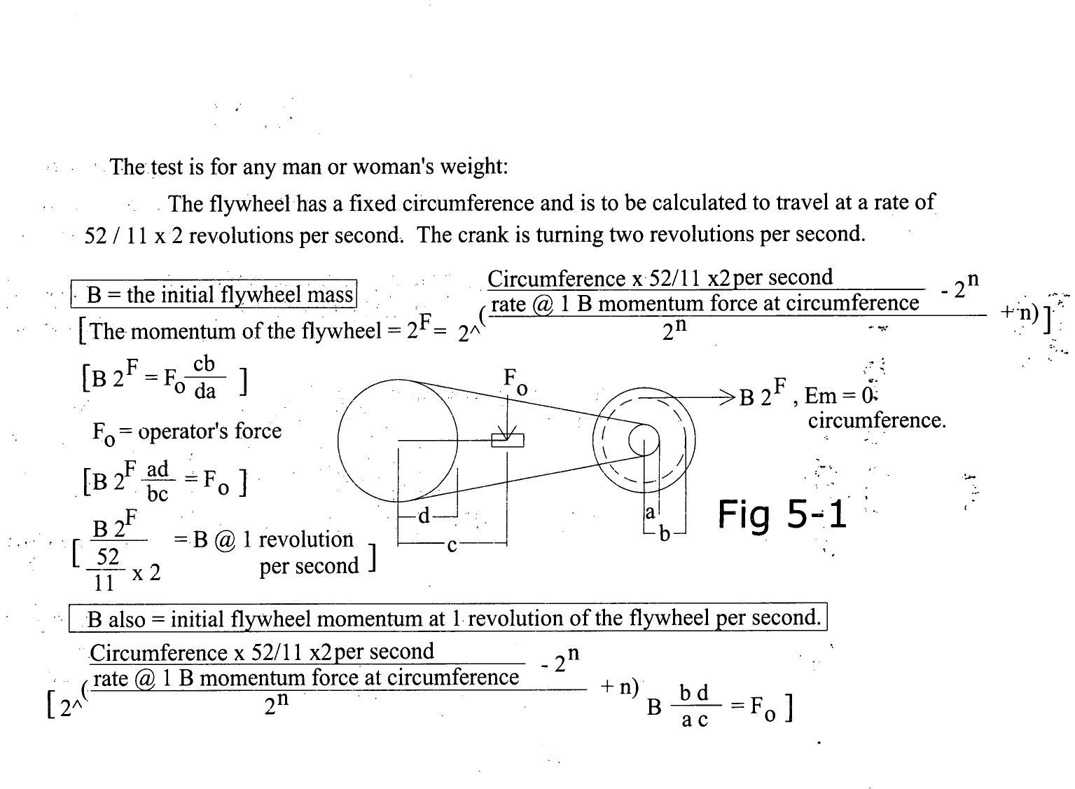

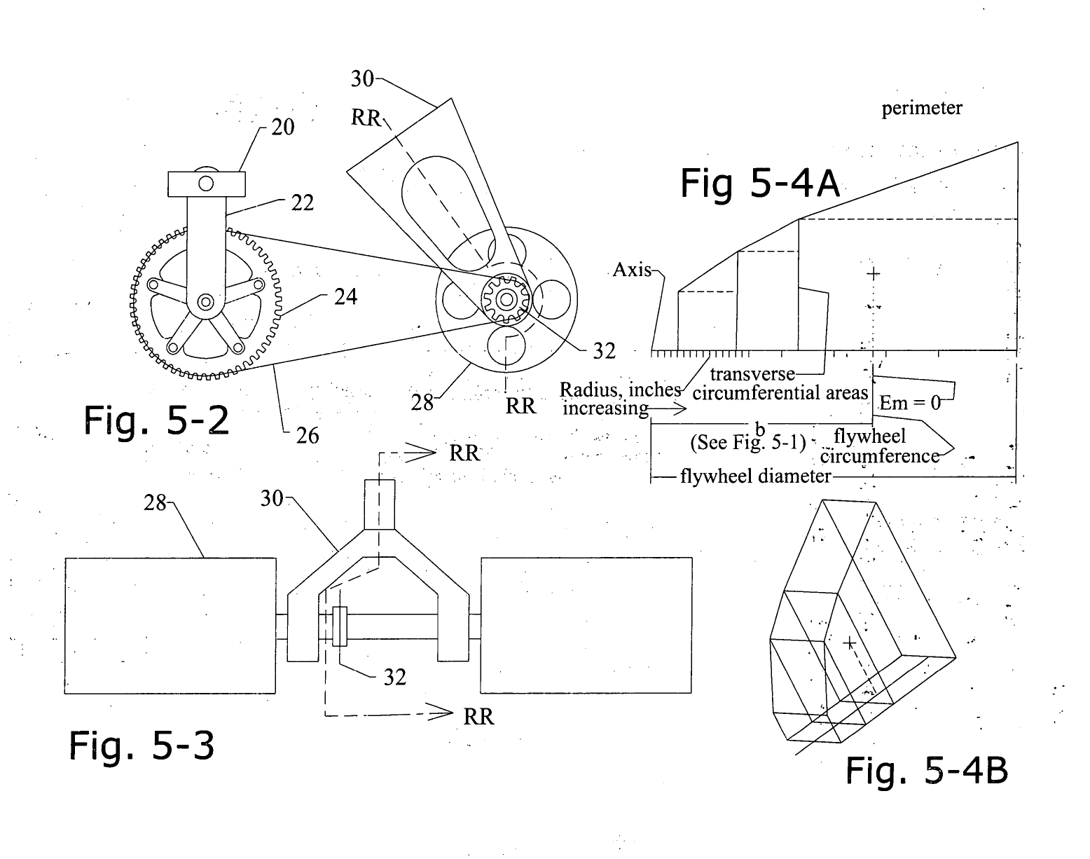

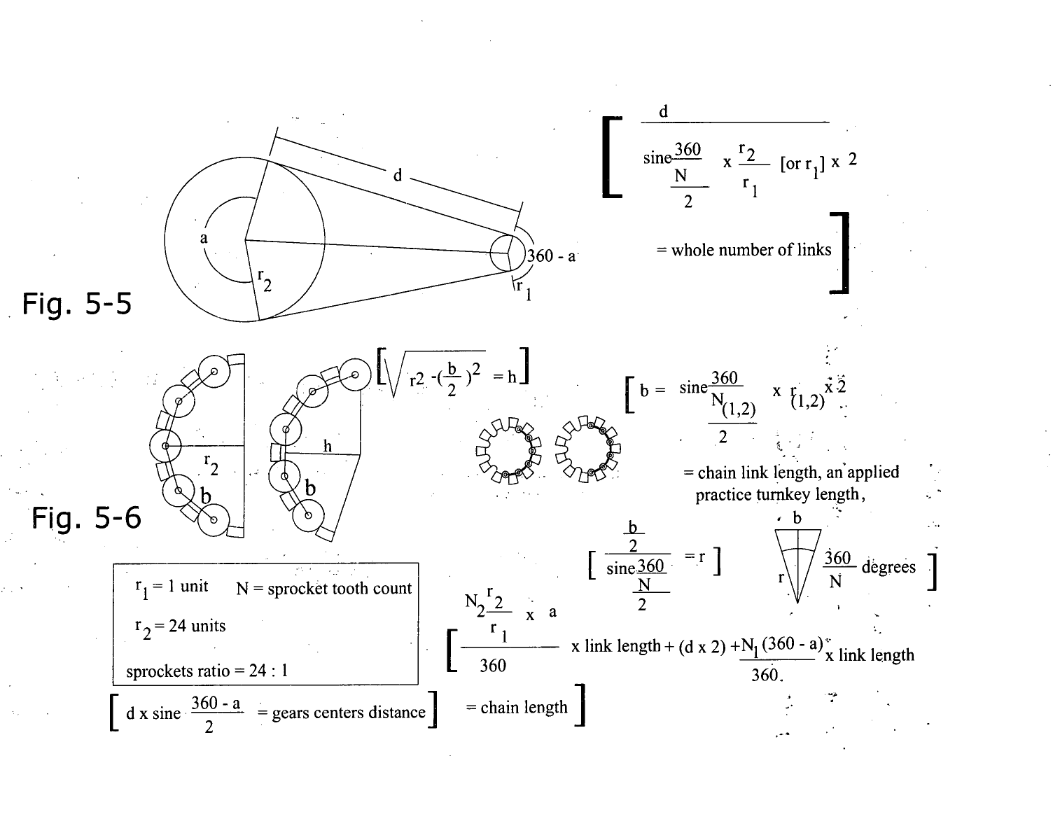

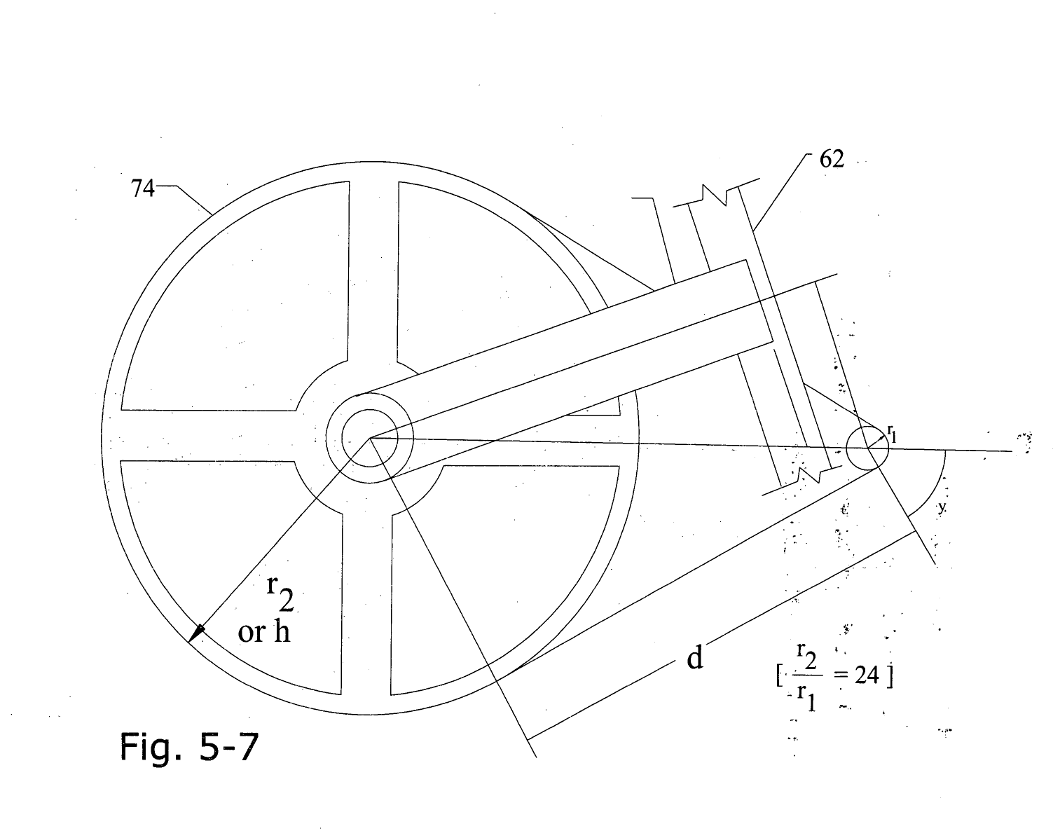

FIG. 5-1: algebraic diagram of flywheel with respect to calibration formulas.

FIG. 5-2: pedal (20) and crank arm (22) turns chain ring (24) and propels chain (26), which in turn turns the flywheel (28) which is hung from the operator's airframe (90) by the flywheel mount (30).

FIG. 5-3: front view of flywheel (28) hung by flywheel mount (30) for operator of great weight.

FIG. 5-4A: force diagram to find the center of the moments of the flywheel to define the circumference radius of the maximum force the flywheel applies.

FIG. 5-4B: isometric force diagram view of material areas at their various radii.

FIG. 5-5: diagram to calculate the sprocket spacing and chain length between the tangent points of the sprockets.

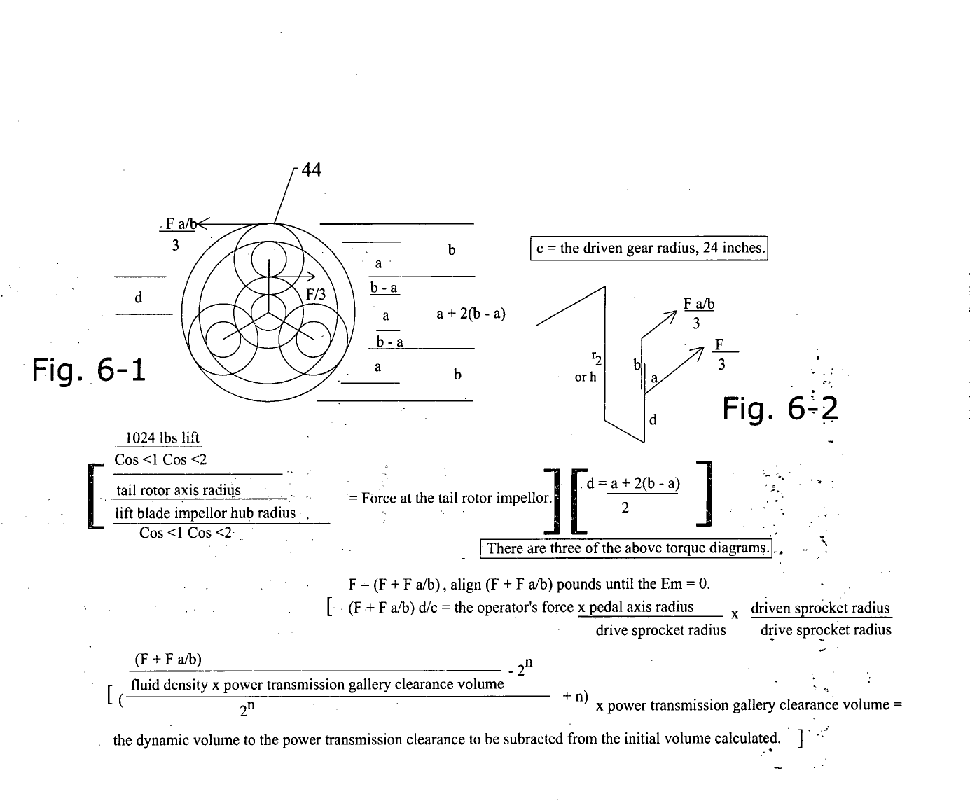

FIG. 5-6: the maximum and minimum radius of the chain on the sprocket.

FIG. 5-7: the actual sprockets ratio diagram and the fact that the frame angles and the chain angles are unrelated. Power train driven sprocket (74).

FIG. 6-1: side view scaled sketch of the epicyclic power transmission (44) to be used in the machines for which applications for patents are intended to be submitted.

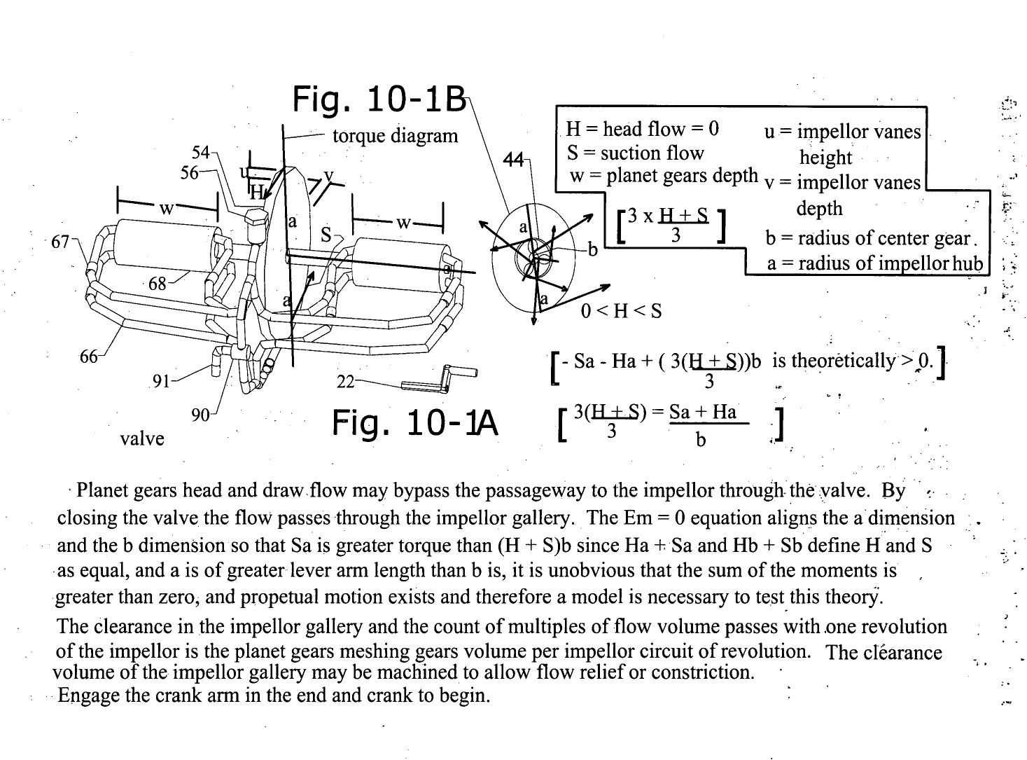

FIG. 6-2: torque diagram of the power transmission assembly, not to scale. Calibration formulas for a portion of the power transmission meshing gears teeth volume. See FIG. 10-1B.

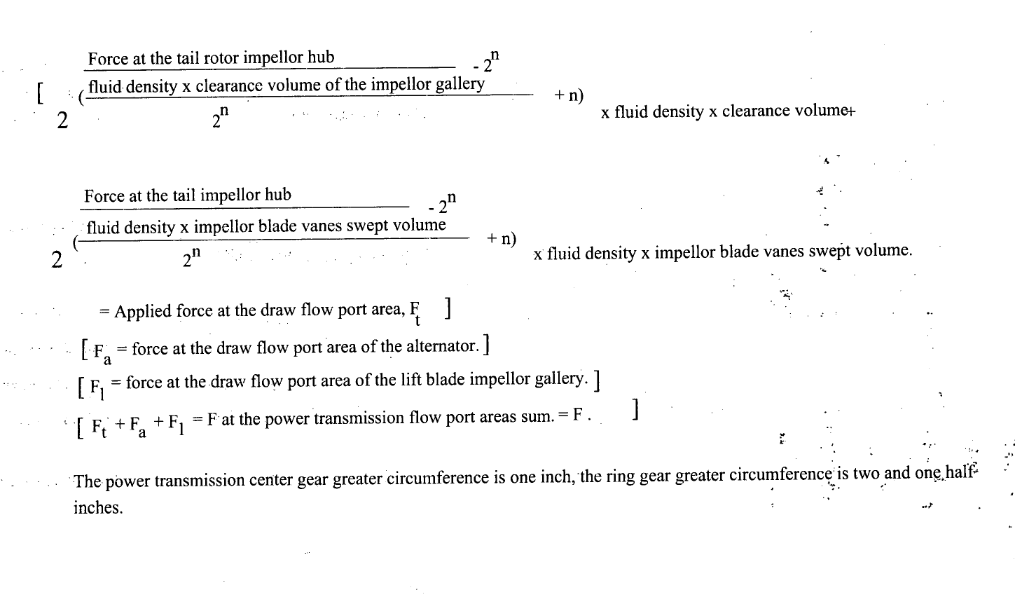

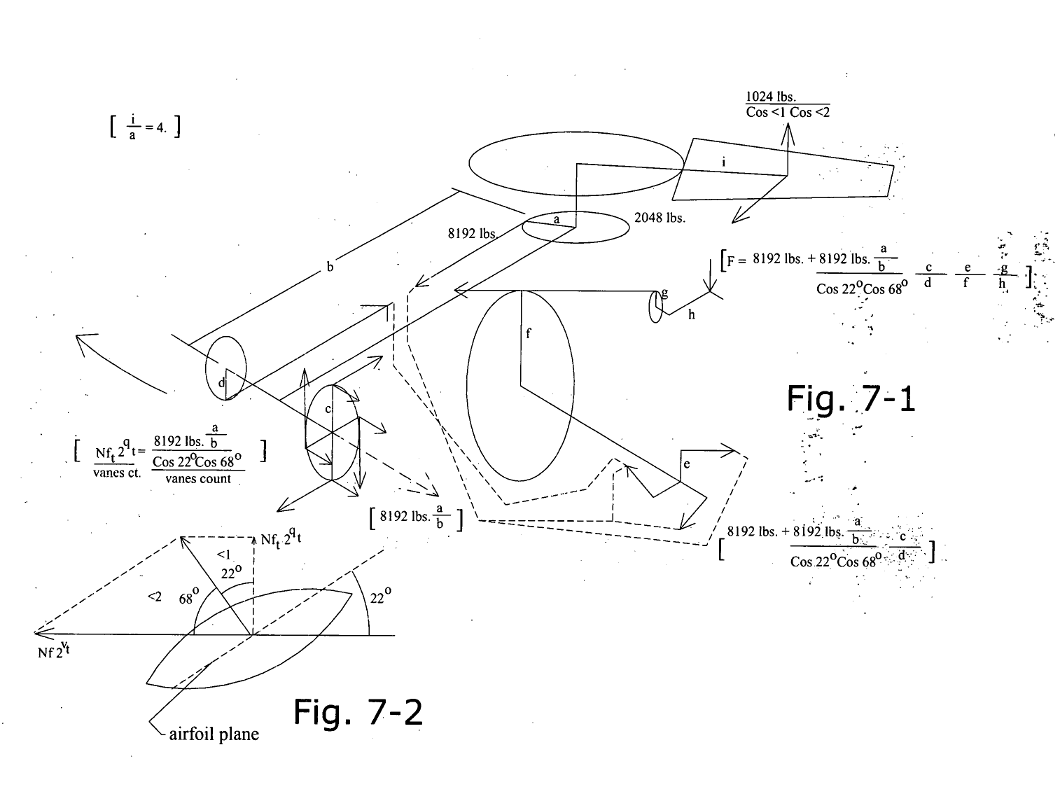

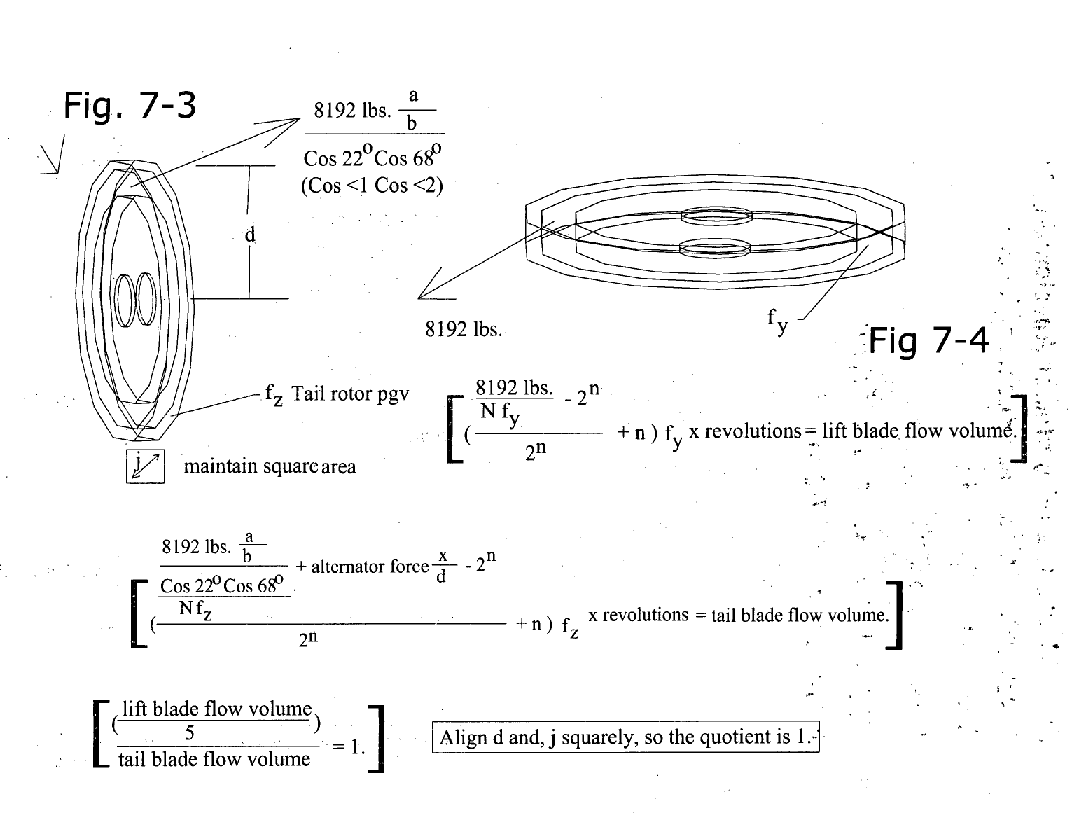

FIG. 7-1: diagram of helicopter forces in equilibrium, with power transmission forces in equilibrium included.

FIG. 7-2: tail blade vane pitch angle and force diagram.

FIG. 7-3: tail rotor impellor gallery volume difference after the (hub) impellor less the blade vanes swept volume is subtracted, and profile of impellor blade vanes is square.

FIG. 7-4: lift blade impellor gallery volume difference after the impellor hub volume is subtracted. Lift blade impellor blade vane profile area is also square. Included impellor blade vanes profile area and diameter to calculate the aligned flow volume to the proportional power transmission meshing gears teeth volume.

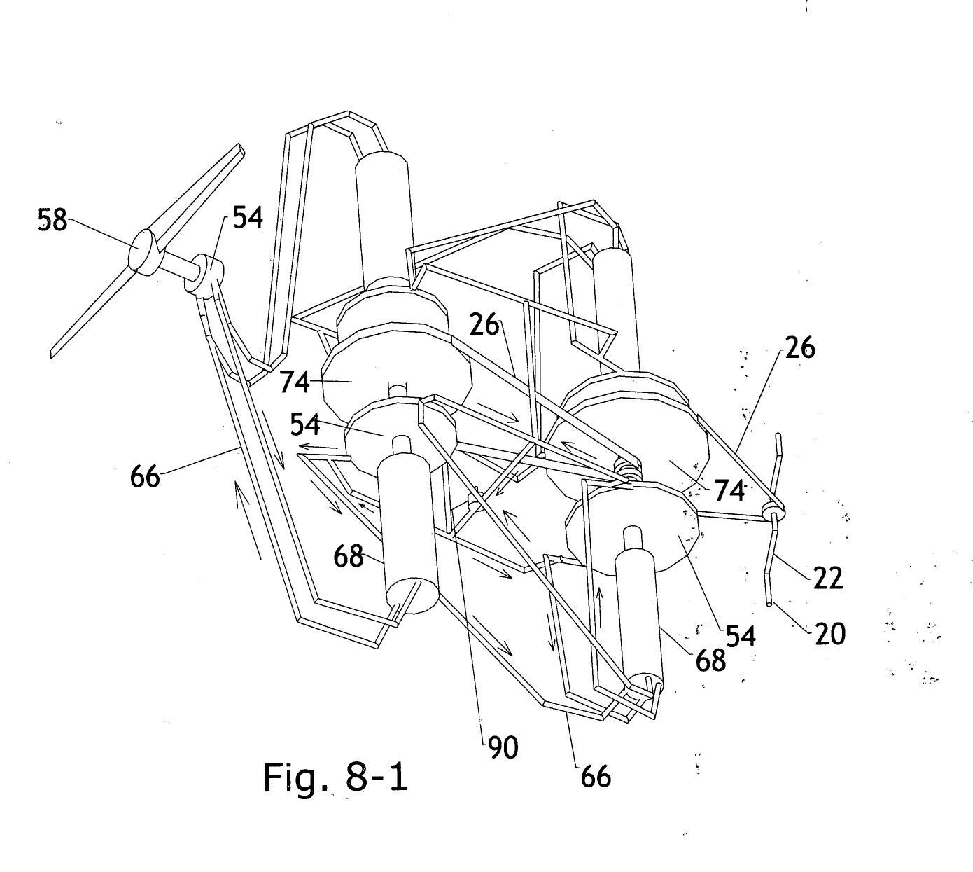

FIG. 8-1: simple diagram of a human powered supersonic powerplant. The pedal (20) attached to the crank arm (22) drives the chain (26) which turns the driven sprocket (74) operating the center gear of the power transmission (68) which pumps hydraulic fluid to the impellor gallery (54) and self perpetuates throughout the power transmission assembly and facilitates the force applied to the flow volume at the final flow to the last impellor gallery (54) turning the blade (58) to withstand supersonic forces applied to it.

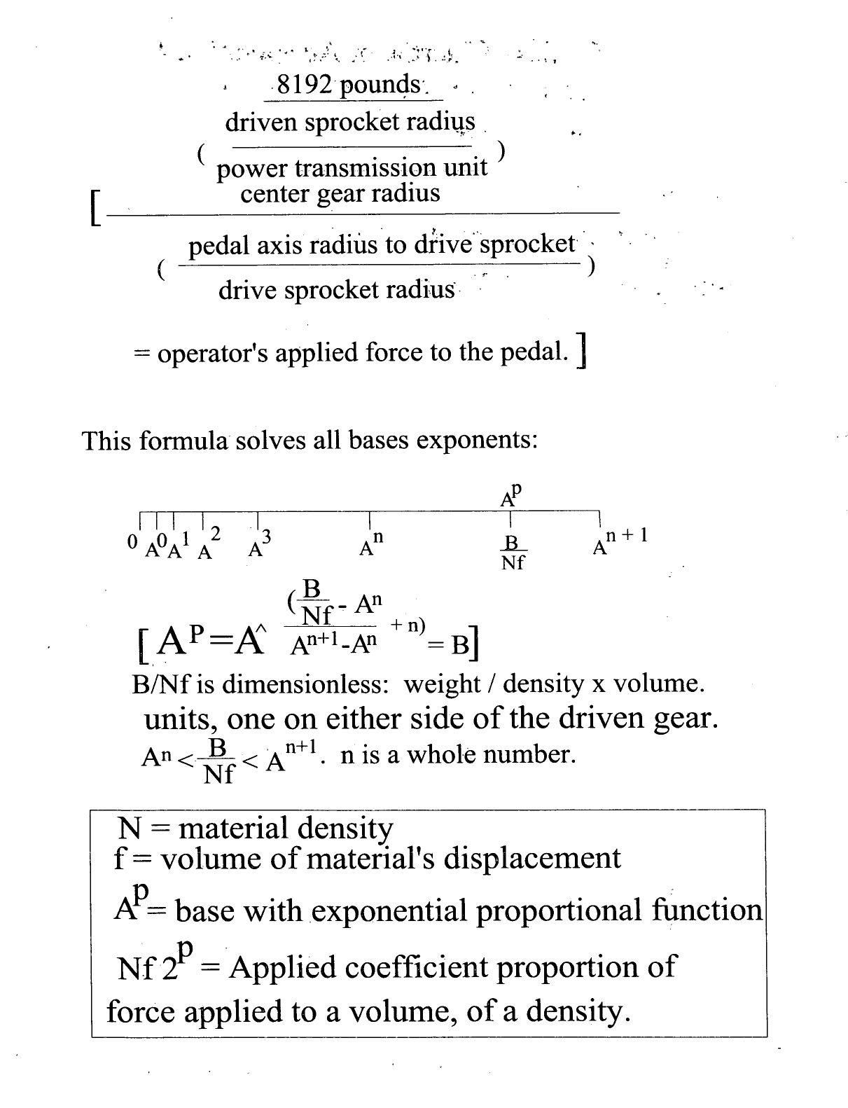

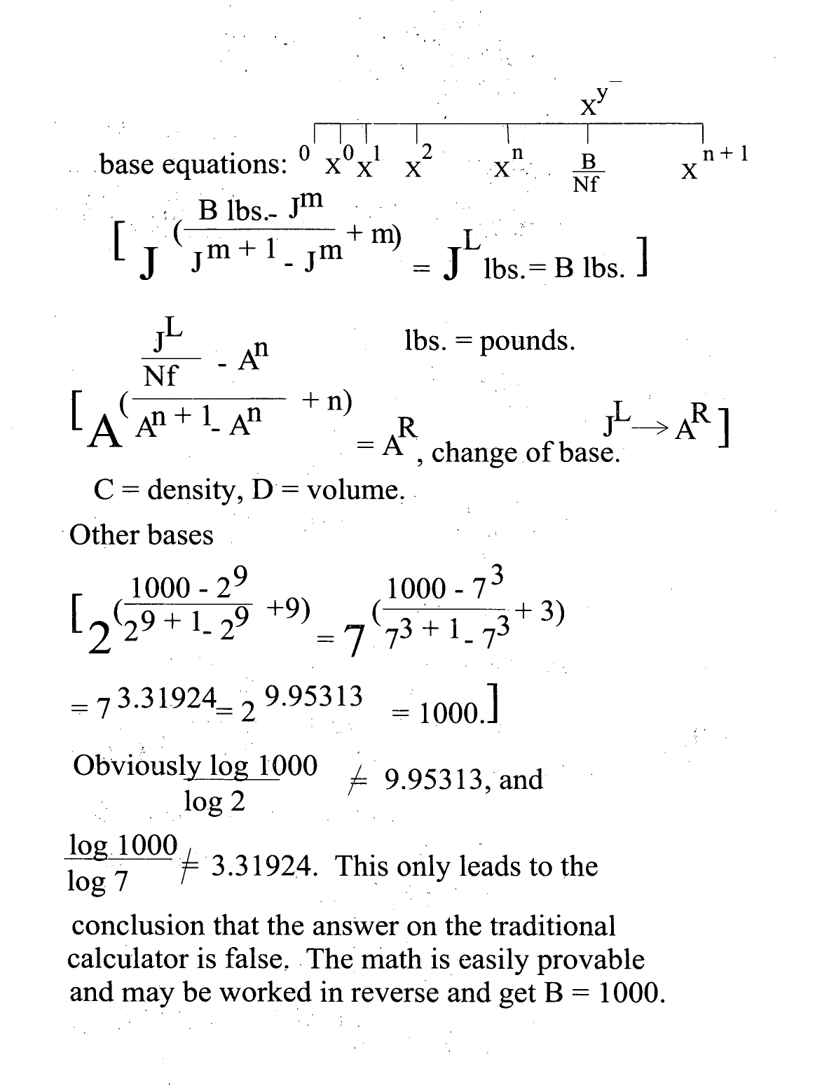

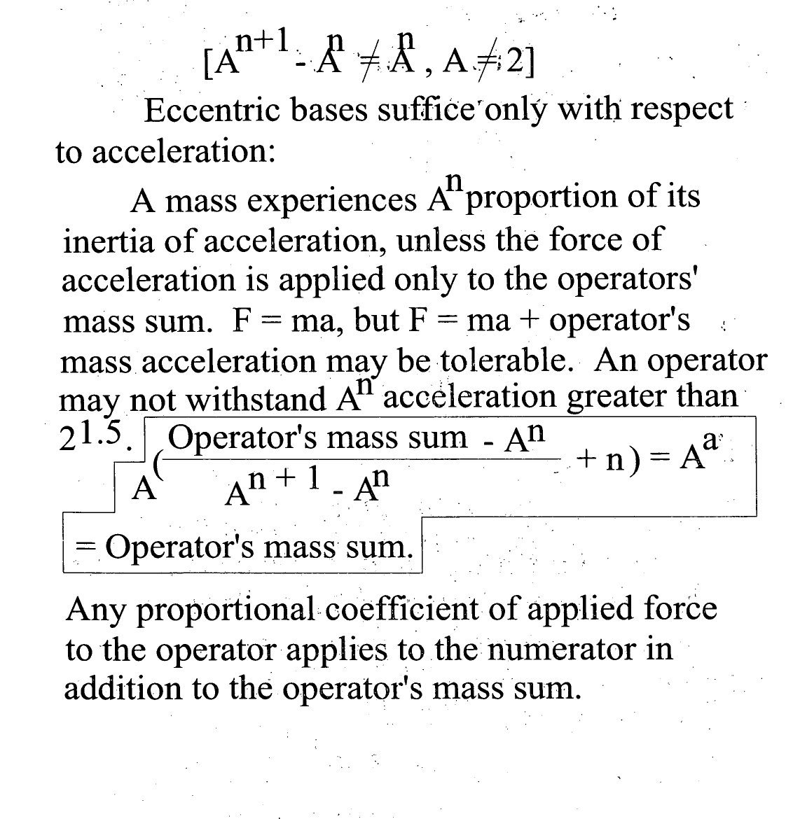

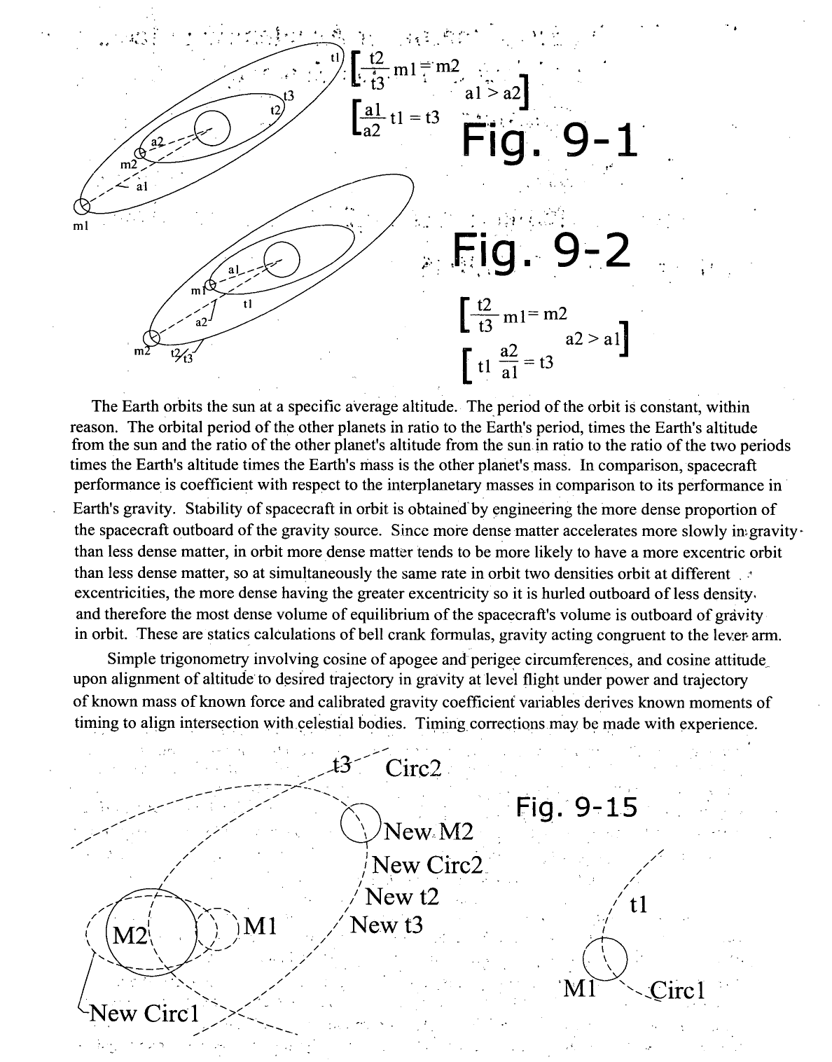

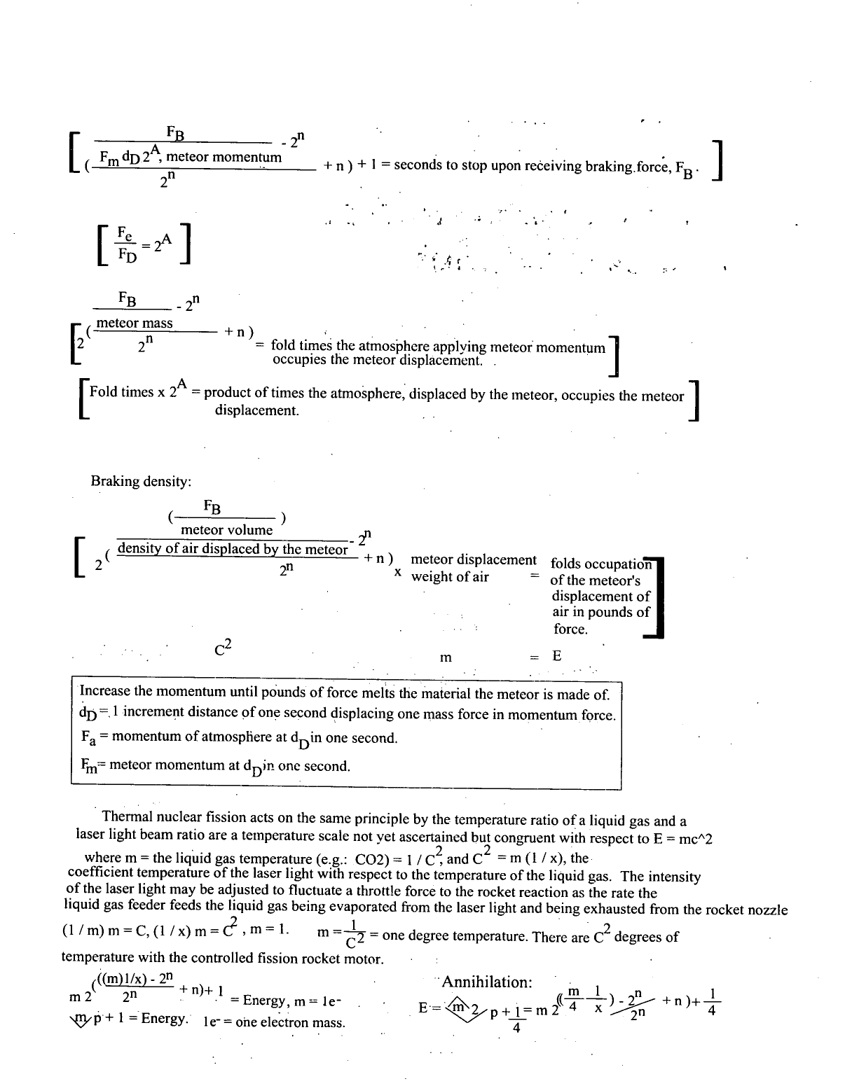

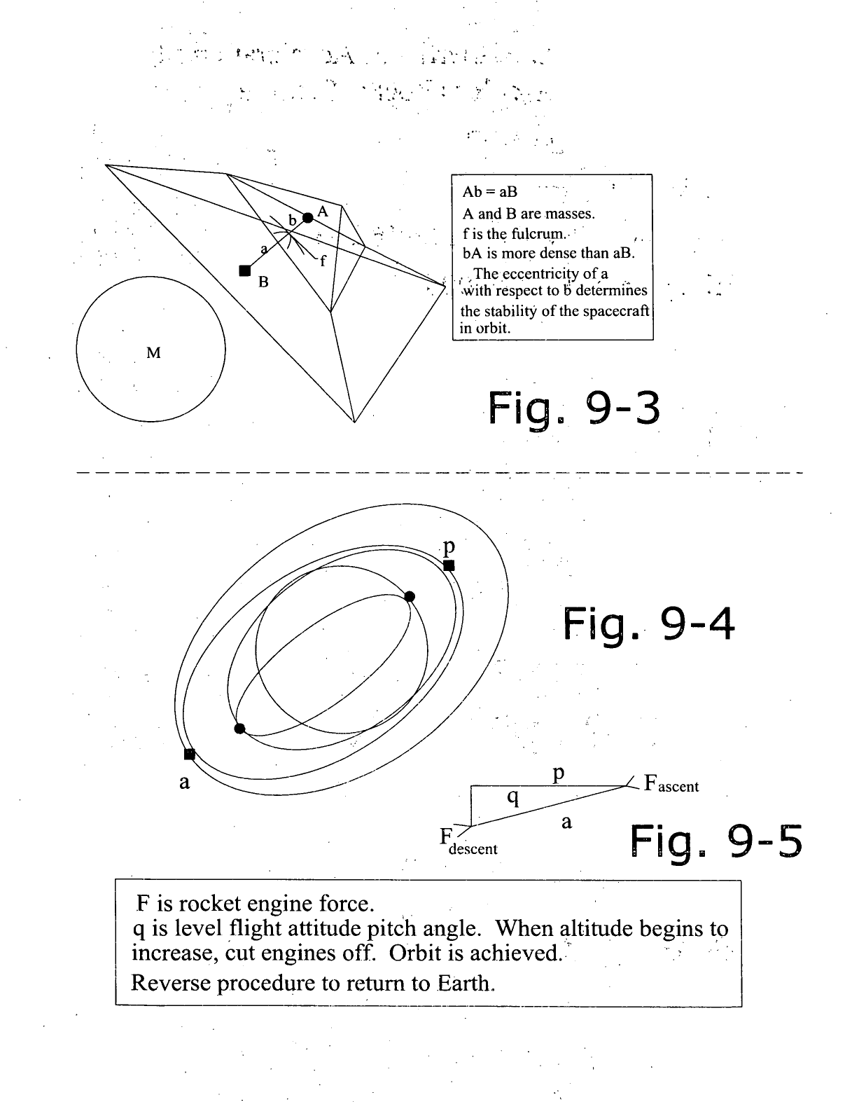

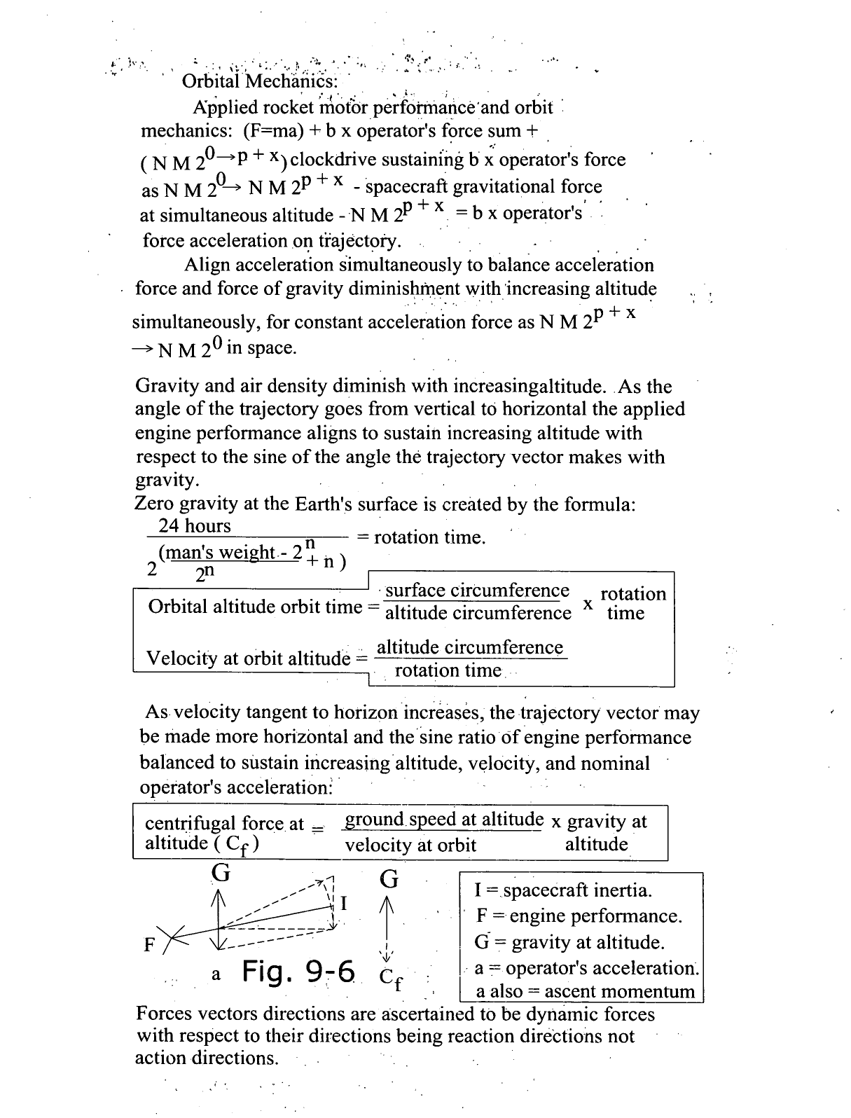

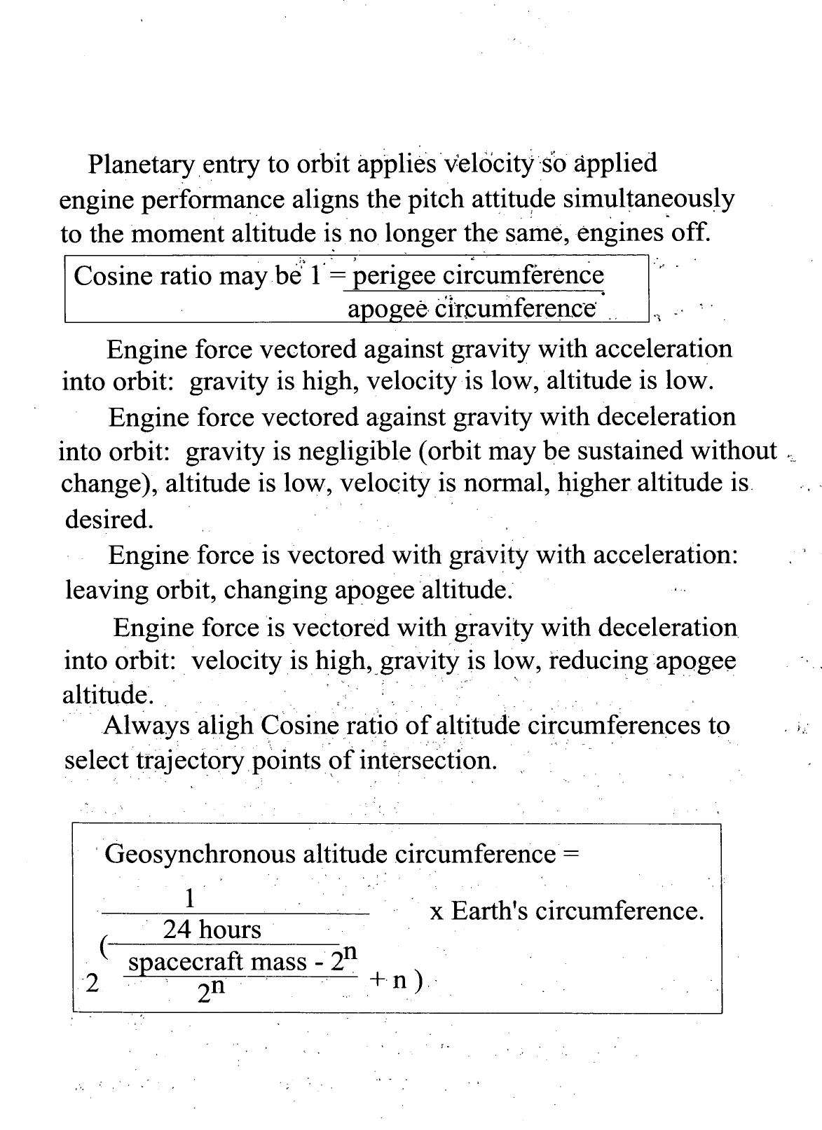

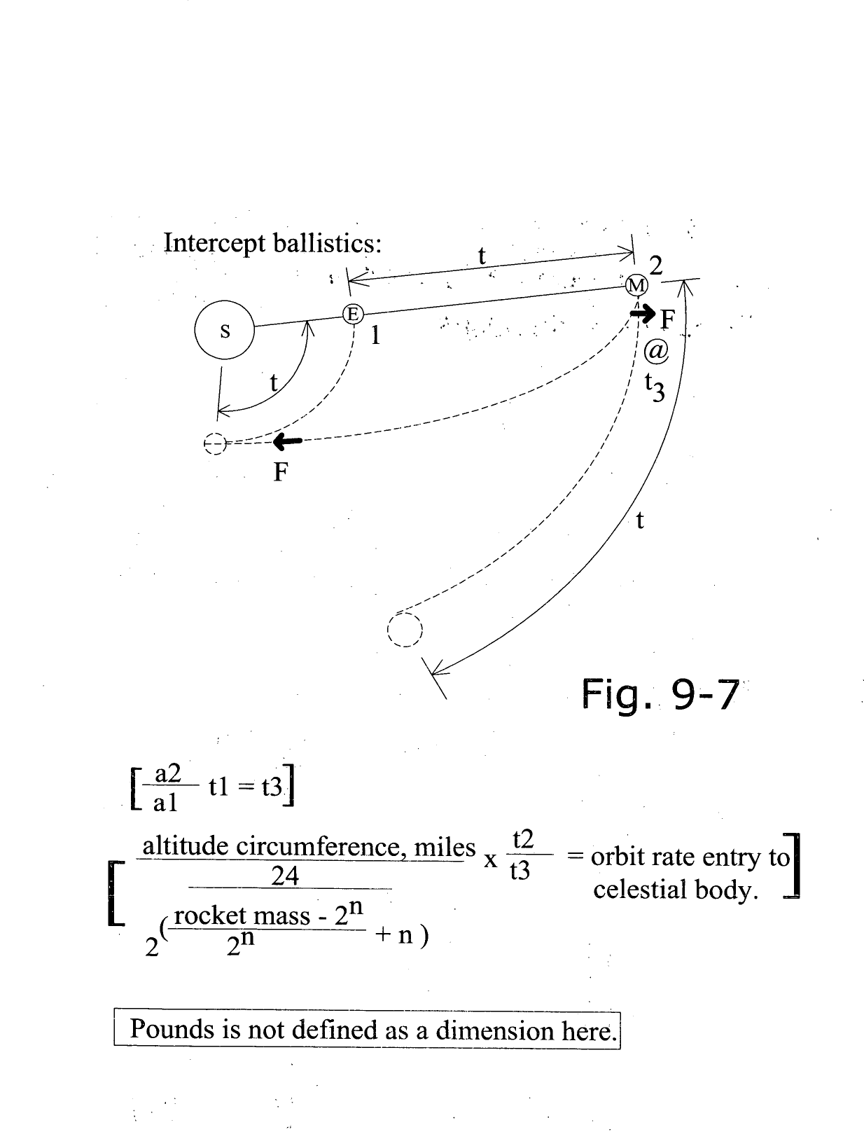

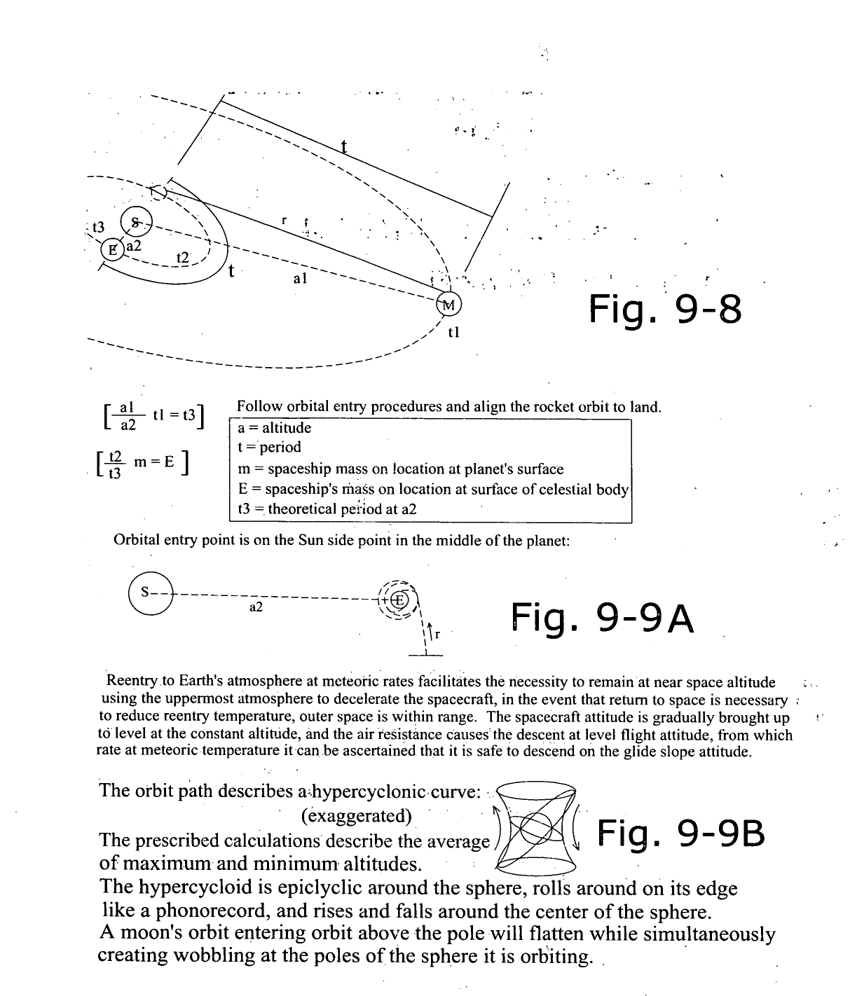

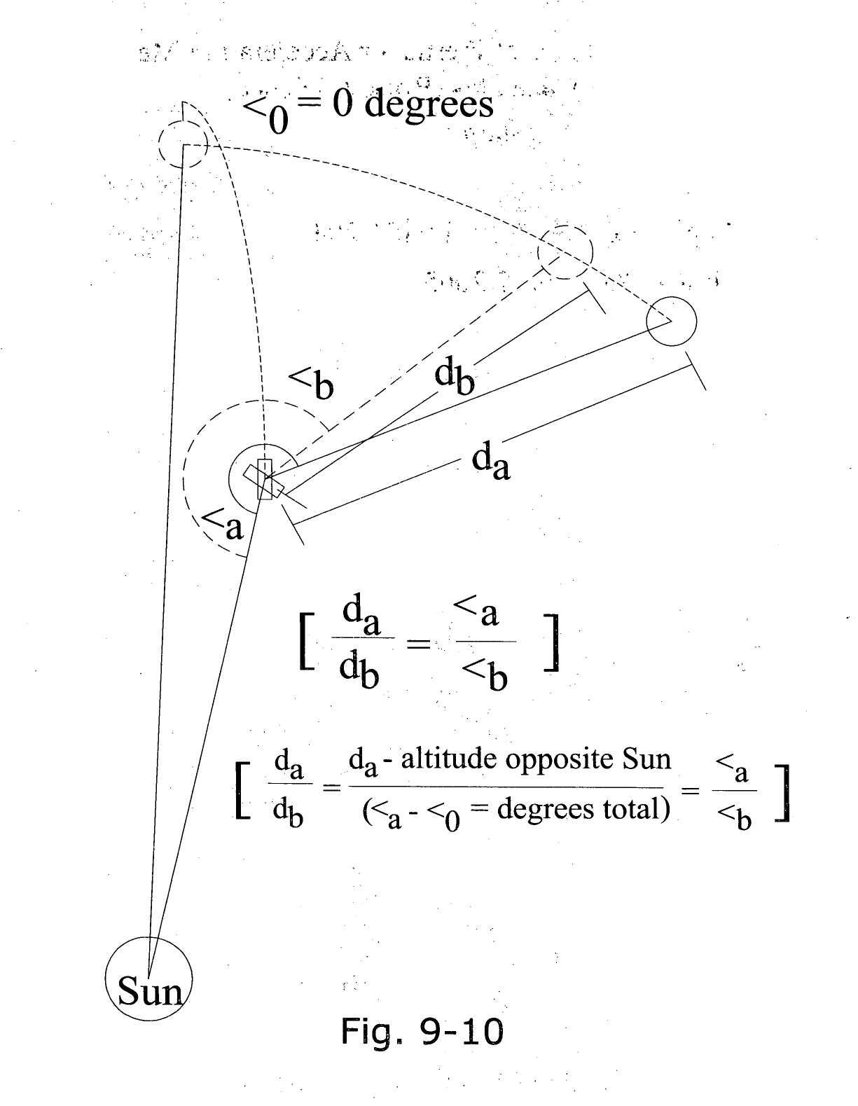

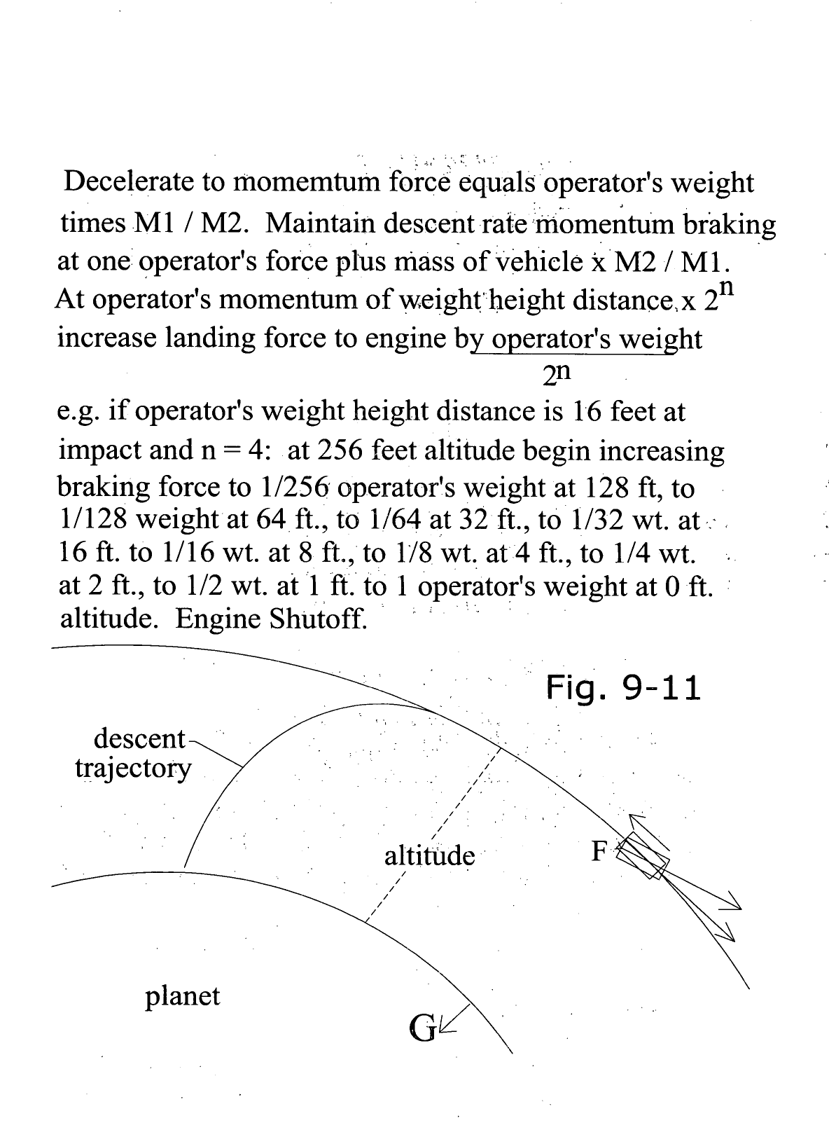

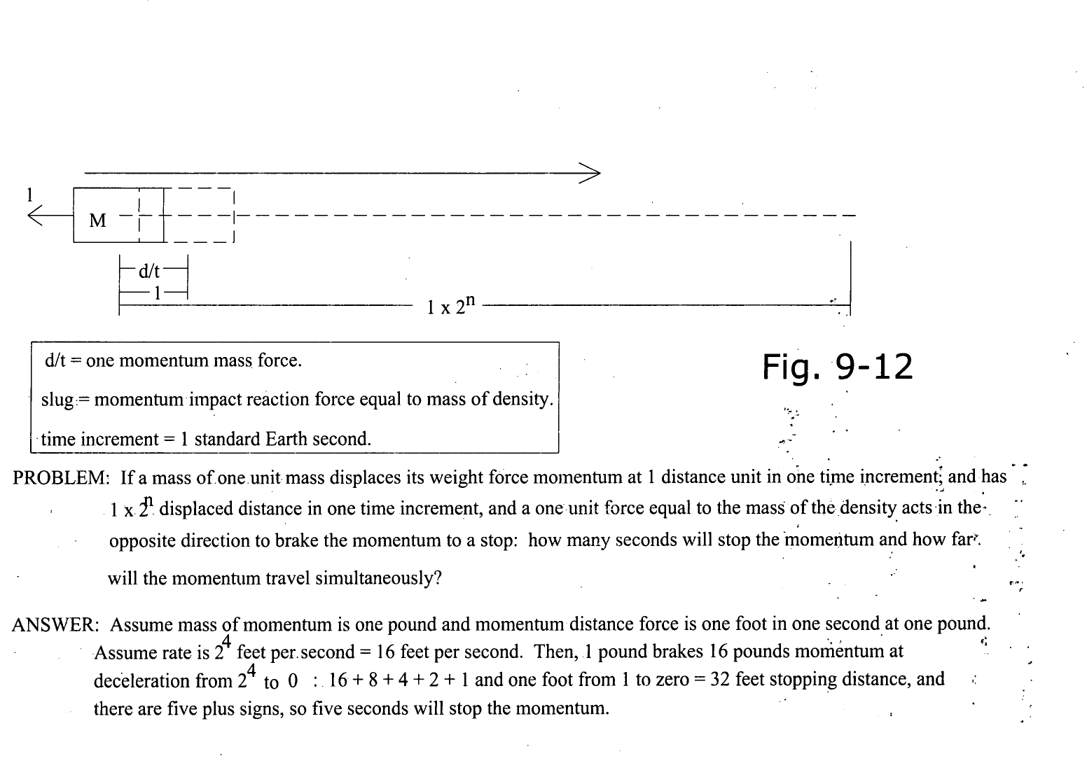

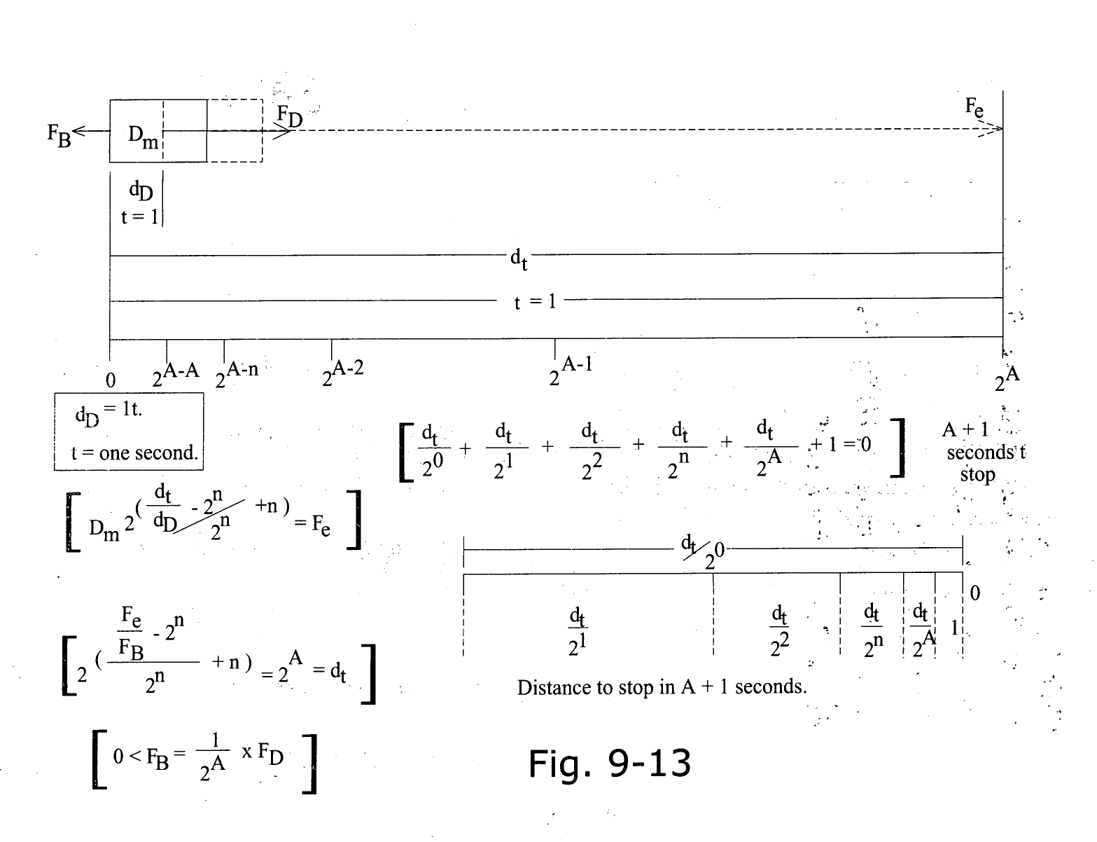

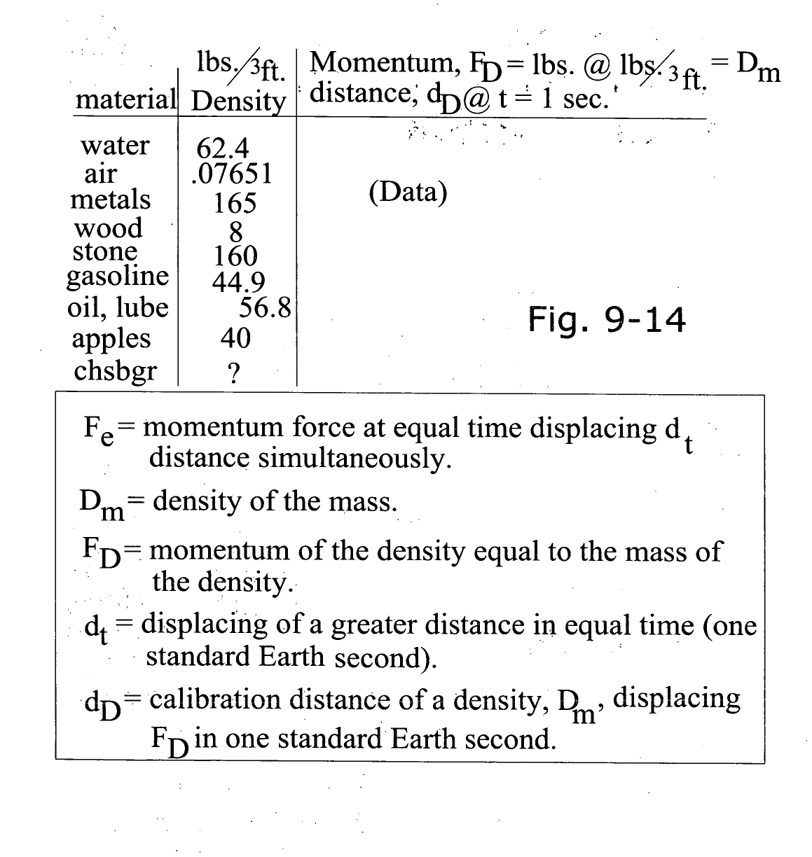

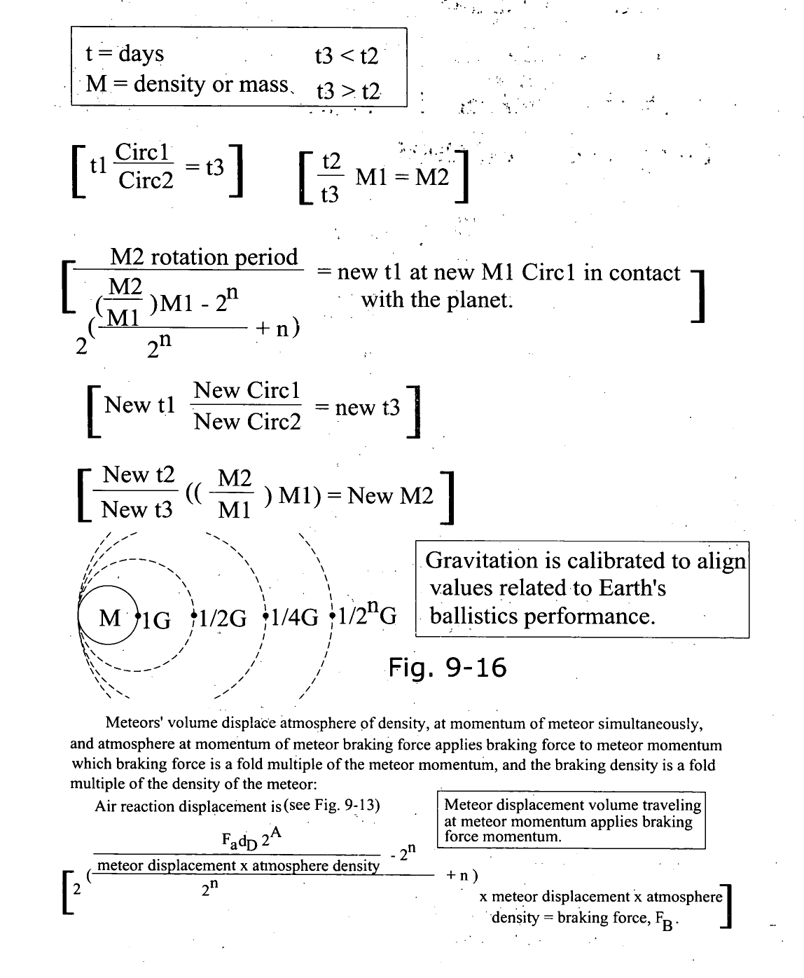

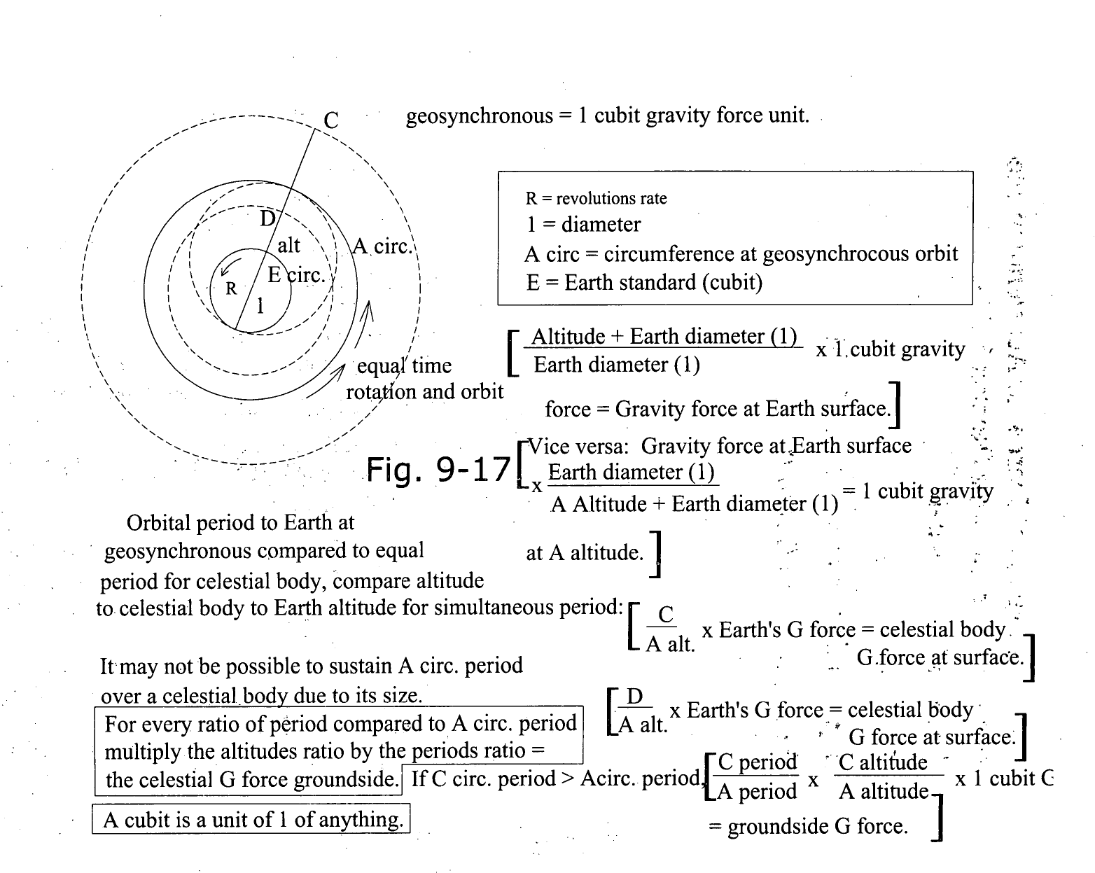

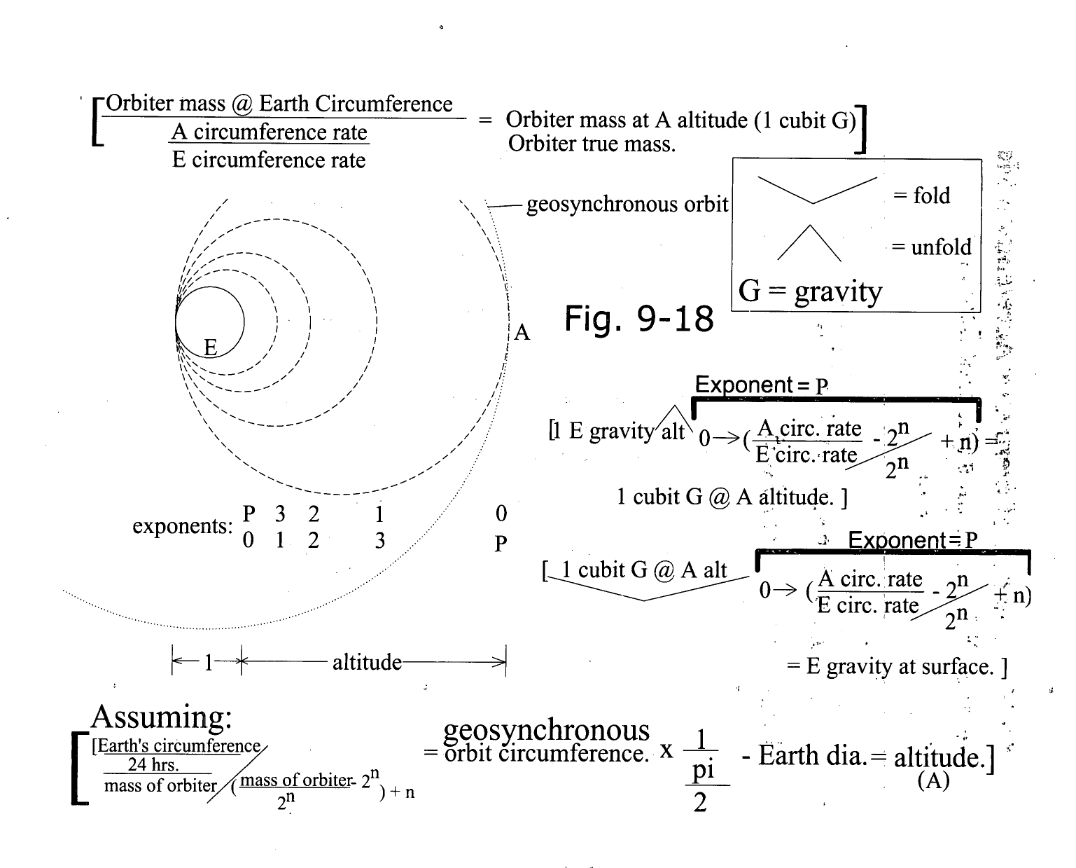

FIG. 9-1: diagram of proportional allowances for calculating the mass of an inferior planet.

FIG. 9-2: diagram of the proportional allowances for calculating the mass of a superior planet.

FIG. 9-3: rendering the attitude of a spacecraft in orbit with respect to its density.

FIG. 9-4: orbit circumferences (a—apogee circumference, p—perigee circumference) with respect to their cosine ratios.

FIG. 9-5: rocket attitude achieving orbit simultaneously with respect to the altitude circumferences cosine ratio, or descending simultaneously maintaining altitude and comfortable deceleration force to operator in gravity.

FIG. 9-6: aligning a rockets engine performance with respect to its trajectory on ascent so centripital force and acceleration won't crush the operators, includes vector of actual trajectory.

FIG. 9-7: timing superior interplanetary planetfall between orbits.

FIG. 9-8: timing inferior interplanetary planetfall between orbits.

FIG. 9-9[[A]]: planning interplanetary planetfall trajectory and reentry.

FIG. 9-9B: hyercylconic curve: orbit

FIG. 9-10: algebraic proportional ratio of change in trajectory angle simultaneously with respect to the change in altitude by degrees divisions, simultaneously with respect to change in distance.

FIG. 9-11: deceleration attitude (FIG.9-5) to maintain altitude and deceleration force comfortable to the operator descent in gravity. Throttle is clock drive and calibrated for applied force simultaneously.

FIG. 9-12: calibration of formulas diagram for FIG. 9-13.

FIG. 9-13: momentum of density and braking force coefficient in simultaneous time.

FIG. 9-14: table of values for densities and their respective momentums forces equal to their individual masses forces in equal time simultaneously.

FIG. 9-15: calculating the gravitational force and period for a moon.

FIG. 9-16: preparing to index gravitational forces using FIGS. 9-17 and 9-18.

FIG. 9-17: calibrating geosynchronous orbit for altitude and period to find gravity at planet's surface.

FIG. 9-18: Ascertainment of geosynchronous altitude with respect to folds of increasing gravity to planet's surface.

FIG. 10-1 [[A]]: hydraulic perpetual motion powerplant design having a flow control valve (90) with a flow control valve lever (91) and epicyclic view (44) of the power transmission, and bellcrank torque diagram and reasoning.

FIG. 10-1B: Torque diagram of the propetual motion fluid force applied forces in the meshing gears teeth volume and impellor gallery at the impellor blade vanes.

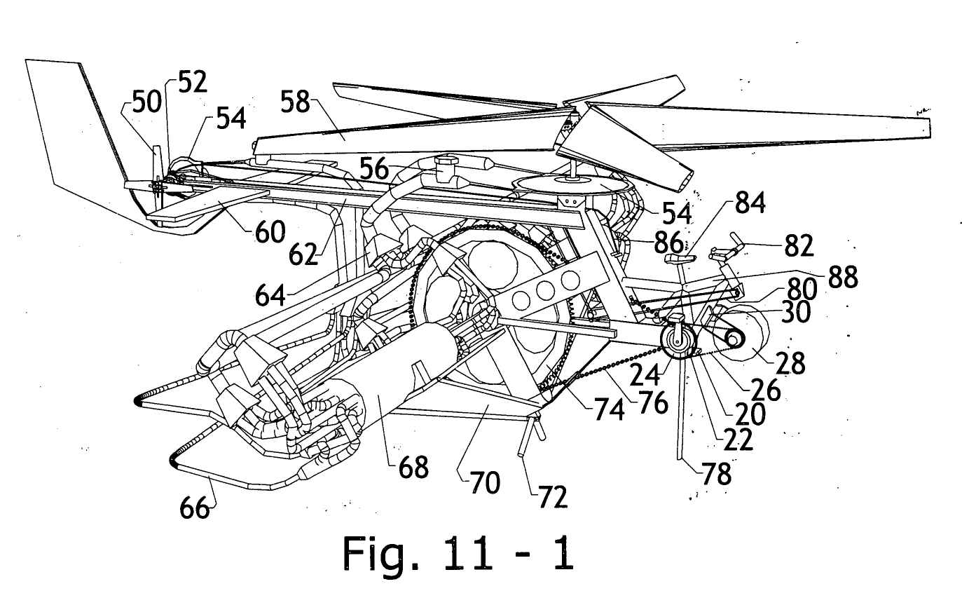

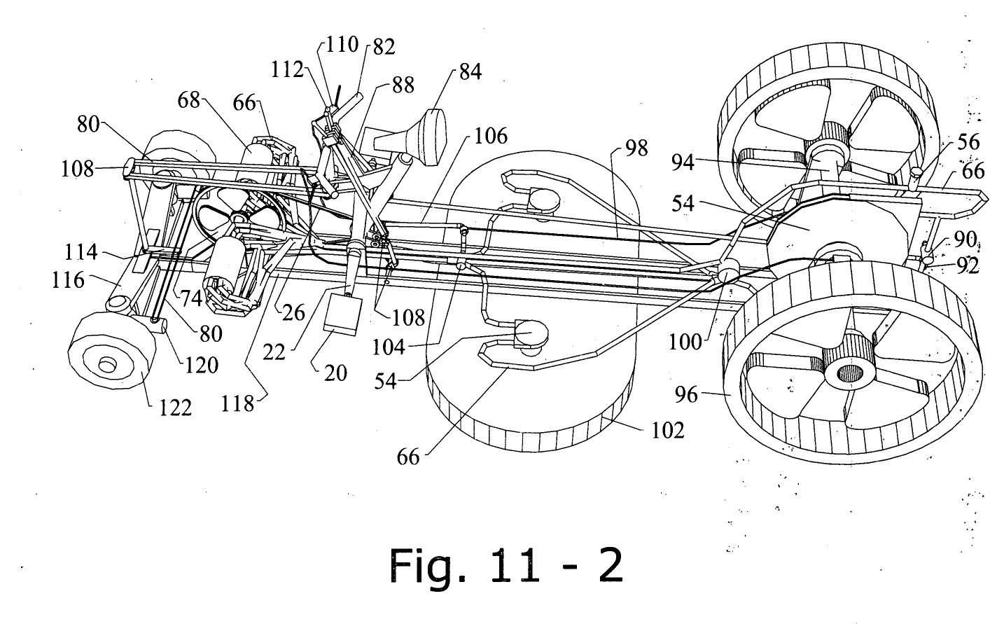

FIG. 11-1: the human powered helicopter rendering having crank and flywheel mechanism (20, 22, 24, 26, 28, 30), horizontal stabilizer (48), tail blade (50), tail blade pitch control mechanism (52), impellor gallery (54) for tail blade locomotion, a fluid reservoir (56) to bleed air from the lines, a lift blade (58), a vertical stabilizer (60), a boom frame member (62), a hydraulic fluid flow collector (64), hydraulic fluid lines (66), a epicyclic power transmission (68), transverse mainframe power transmission support (70), rear landing gear (72), power train driven sprocket (74), power train main drive chain (76), front landing gear (78), tail rotor pitch control linkage (80), handlebars (82), saddle (84), and tail rotor blade vanes pitch trim control (86).

FIG. 11-2: human powered lawn tractor having the same parts (20, 22, 26, 54, 66, 68, 80, 82, 84, 88, 90) including the connecting rod connection (92), drive wheel axle (94), drive wheel (96), brake cable and casing (98), reverse flow valve (100), blades guard (102), blades engaging valve (104), forward/reverse connecting rod (106), bellcrank (108), handbrake (110), forward/reverse-blades engage/disengage-idle/move control levers (112), steering control arm (114), A-frame (116), main tractor frame (118), steering arm (120), and tire (122).

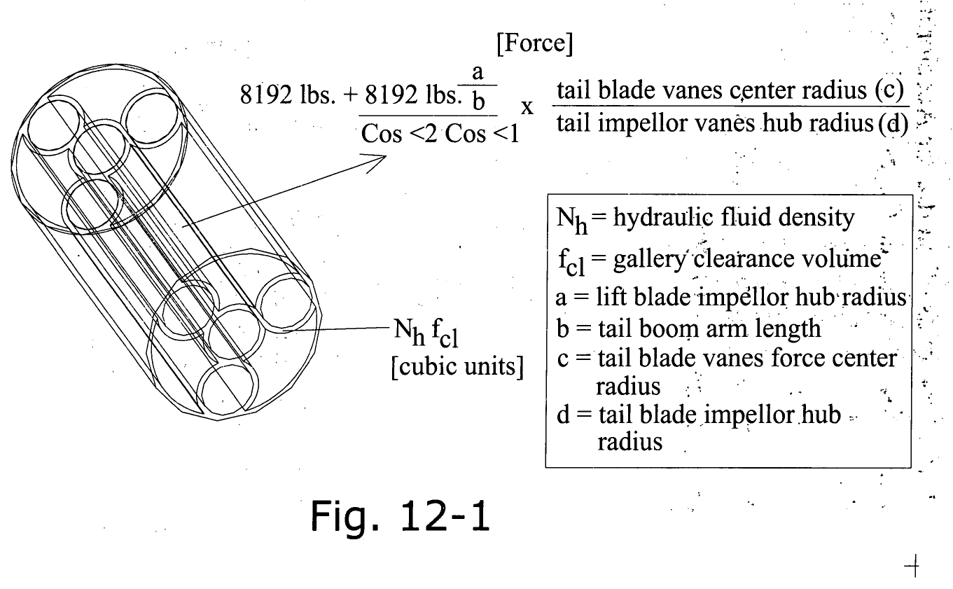

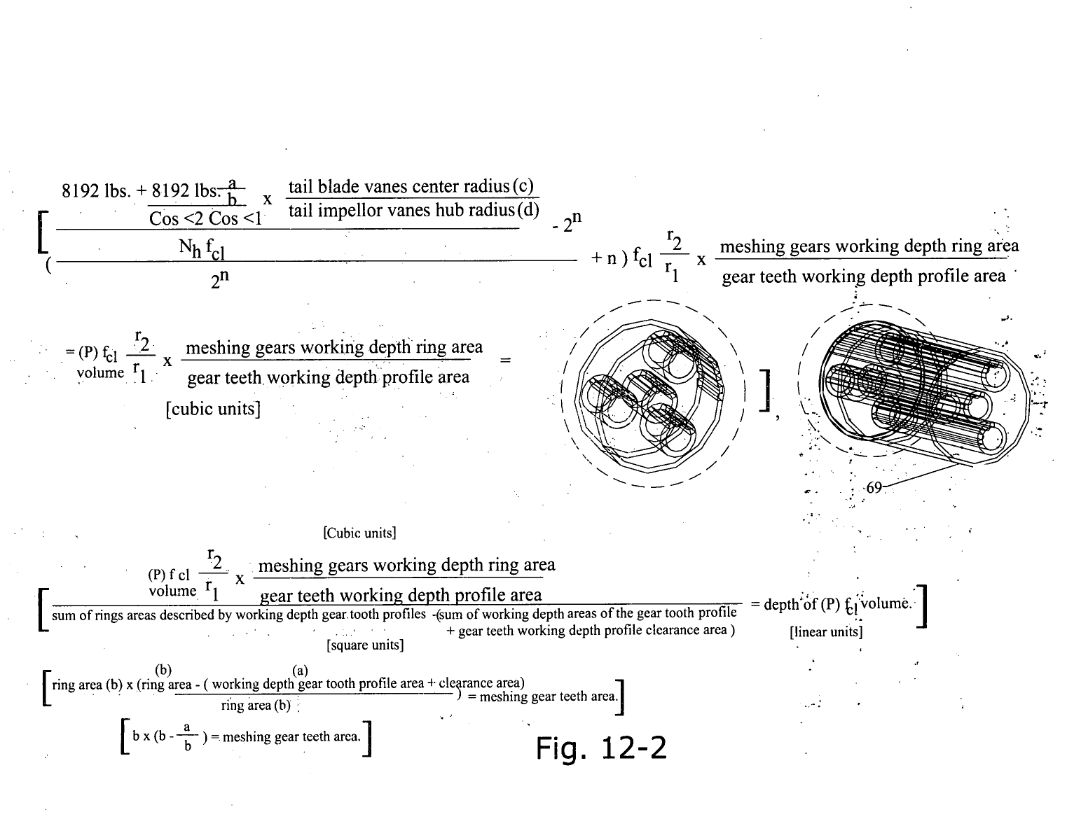

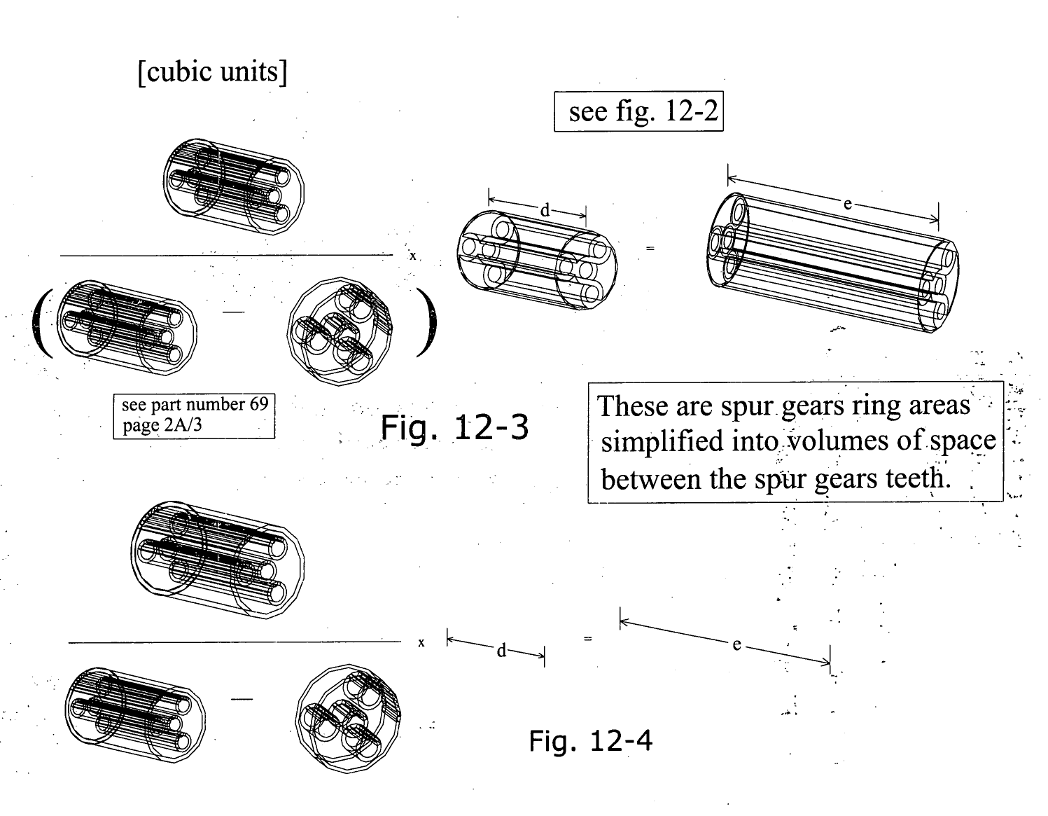

FIG. 12-1: diagram of epicyclic gears clearance volume, applied force to hydraulic fluid to the same volume, and legend of particular parameters leading up to the applied force, which applied force may include extraneous variables which may increase the force applied.

FIG. 12-2: calculating the proportion of clearance flow volume in the full volume of the meshing epicyclic gears volume of full revolution, and the basic cylinder equation for calculating the depth for the calculated volume of the clearance flow using the areas of the epicyclic gears described cylinder profiles.

FIG. 12-3: the calculation of the volume between the spur gears teeth to include the flow volume of the epicyclic gears clearance proportion so the final volume depth of the power transmission gears displaces the forces in the epicyclic gears clearance volume flow and the draw forces flow to be simultaneously equal.

FIG. 12-4: the calculation to define the new depth dimension after the clearance volume flow and draw force flows are made equal.

### CONCLUSION, RAMIFICATIONS, AND SCOPE OF INVENTION

Please read thus that the information contained in this process is useful for the scientist, mechanical draftsman, engineer, and hobby enthusiast to construct all forms of transportation to any scale. The applicant hopes this process will become a college subject and develop aerospace into a relatively simple concept. Concepts of invention included herein are intended to comprise the scope of the invention.

1. Problems solved using iconoclastic algorisms to resolve previously unsolved problems:
(A) Mathematics by which applied force to geometric displacement volume may be calculated for lift, thrust, and drag and balanced in equilibrium moments; equations for the calculation of maximum force variables' coefficient values throughout the power transmission equilibrium moments of the human powered powerplant, equations for calculating the geometry of the fans vanes and impellor blades, the momentum of, mass, and sprockets engineering of the flywheel transmission, the gears designs of the power transmission, the aerobatic equilibrium of flight mechanics of symmetrical and unsymmetrical geometrical bodies-in three dimensions, maximum effective rotary airfoil equations, buoyancy equilibrium moments of vessels, planetary mechanics, meteor mechanics, controlled fission mechanics and a theoretical controlled fission rocket motor concept, orbital mechanics and fly-by-the-seat-of-your-pants interplanetary ballistics, the law of applied base functions and change of base in longhand finding the contemporary calculator logarithm function fallible and to be corrected by the patentability of this process, iconoclastic geometry, algebra, trigonometry and an algorism for calculating momentum for all densities at any velocity, with variable values inputs, equations to calculate the precision geometry of power transmission parts dimensions for maximum performance, perpetual motion equations, a perpetual motion model diagram, a diagram of a supersonic human powered powerplant, a diagram of a human powered helicopter, a diagram of a human powered lawn-tractor, and the understanding that the capability of the software toolbar tools will be able to balance all types of transportation experiencing all their mechanical forces acting in equilibrium on them at any attitude.
(B) An individual software package completely compiled to be a user friendly database incorporating previously known mechanical engineering and any other previously known, and discovered mathematical formulas independently contributed to and intended to be interpolated into existing user friendly computer aided design software to be owned and used by the engineer, scientist, mechanical draftsman, technologist, and common and ordinary hobby enthusiasts for the prospects of invention and the creation of unique products.
